(19) United States
(12) Patent Application Publication
(10) Pub. No.: US 2025/0387779 A1
(43) Pub. Date: Dec. 25, 2025

(54) METHOD FOR AMMONIA DECOMPOSITION USING CARBON MATERIAL SUPPORTED METAL CATALYST

(71) Applicants: Saudi Arabian Oil Company, Dhahran (SA); King Abdullah University of Science and Technology, Thuwal (SA)

(72) Inventors: Aadesh Harale, Dhahran (SA); Aqil Jamal, Dhahran (SA); Cafer Tayyar Yavuz, Thuwal (SA); Seokjin Kim, Jinju-si (KR)

(21) Appl. No.: 18/752,976

(22) Filed: Jun. 25, 2024

(51) Int. Cl. B01J 23/46; B01J 21/18; B01J 35/00; B01J 38/02; C01B 21/02

(52) U.S. Cl. CPC B01J 23/462; B01J 21/185; B01J 35/19; B01J 38/02; C01B 21/02

(57) ABSTRACT

A method for decomposing ammonia (NH₃) to hydrogen (H₂) and nitrogen (N₂) includes contacting a H₂-containing feed gas stream with a carbon material supported metal (M-C) catalyst at a temperature of about 500° C. to form a reduced M-C catalyst; contacting an NH₃-containing feed gas stream with the reduced M-C catalyst at a temperature of about 200 to about 600° C. thereby converting at least a portion of the NH₃ to H₂ and N₂, and regenerating the M-C catalyst to form a regenerated M-C catalyst, and producing a residue gas stream leaving the reactor; and separating the H₂ from the residue gas stream to generate a H₂-containing product gas stream. The regenerated M-C catalyst is substantially free of agglomerated particles and sintered particles.

### TECHNICAL FIELD

The present disclosure relates to an ammonia (NH₃) decomposition method, more particularly, to a method for decomposing NH₃ to hydrogen (H₂) and nitrogen (N₂) using a carbon material supported metal (M-C) catalyst. The present disclosure also provides a method for preparing the M-C catalyst, more particularly, to a method for preparing a carbon material supported ruthenium (Ru—C) catalyst.

### BACKGROUND

Hydrogen (H₂) is recognized as a viable solution for meeting global energy demands and reducing carbon emissions. Despite its potential, challenges persist in the storage and transportation of H₂, hindering its widespread adoption. NH₃ has emerged as a competitive H₂ carrier due to its carbon-free nature. The decomposition of NH₃ into H₂ and N₂ provides a promising approach to address these challenges.

Due to the endothermic nature of NH₃ decomposition, the extraction of H₂ from NH₃ is often carried out at a temperature of about 700 to 800° C. using noble metal catalysts. The requirement for high temperatures and costly catalysts renders this process challenged for industrial ammonia cracking. Therefore, the utilization of NH₃ as a H₂ carrier has been limited by the lack of an efficient decomposition process and catalyst. Accordingly, there is a need to develop more efficient and cost-effective methods for NH₃ decomposition and generation of H₂.

### SUMMARY

In an exemplary embodiment, a method for decomposing ammonia (NH₃) to hydrogen (H₂) and nitrogen (N₂) is provided. The method includes introducing a H₂-containing feed gas stream into a reactor comprising a carbon material supported metal (M-C) catalyst; passing the H₂-containing feed gas stream through the reactor to contact the H₂-containing feed gas stream with the M-C catalyst at a temperature of about 500° C. to form a reduced M-C catalyst; introducing and passing an NH₃-containing feed gas stream through the reactor to contact the NH₃-containing feed gas stream with the reduced M-C catalyst at a temperature of about 200 to about 600° C. thereby converting at least a portion of the NH₃ to H₂ and N₂, regenerating the M-C catalyst to form a regenerated M-C catalyst, and producing a residue gas stream; and separating the H₂ from the residue gas stream to generate a H₂-containing product gas stream.

In some embodiments, the M-C catalyst contains a metal selected from the group consisting of ruthenium (Ru), iridium (Ir), platinum (Pt), nickel (Ni), cobalt (Co), iron (Fe), rhodium (Rh), palladium (Pd), Molybdenum (Mo), and mixtures thereof.

In some embodiments, the regenerated M-C catalyst is substantially free of agglomerated particles and sintered particles.

In some embodiments, the M-C catalyst is made in a form selected from the group consisting of powders, pellets, a membrane, a monolithic structure, and combinations thereof.

In some embodiments, the metal is present in the M-C catalyst in an amount of about 0.5 to about 30 wt. % of the M-C catalyst. In some embodiments, the M-C catalyst further contains one or more alkali and alkaline earth metal selected from the group consisting of sodium (Na), potassium (K), rubidium (Rb), cesium (Cs), barium (Ba), calcium (Ca), magnesium (Mg), and mixtures thereof.

In some embodiments, the one or more alkali and alkaline earth metal is present in the M-C catalyst in an amount of about 0.01 to about 8 wt. % of the M-C catalyst.

In some embodiments, the H₂ is present in the H₂-containing feed gas stream at a concentration of about 0.01 to about 20 vol. % based on a total volume of the H₂-containing feed gas stream.

In some embodiments, the passing the H₂-containing feed gas stream is performed at a flow rate of about 10 to about 50 milliliters per minute (mL/min).

In some embodiments, the NH₃ is present in the NH₃-containing feed gas stream at a concentration of about 90 to about 99.99 vol. % based on a total volume of the NH₃-containing feed gas stream.

In some embodiments, the introducing and passing the NH₃-containing feed gas stream is performed at a flow rate of about 10 to about 200 mL/min.

In some embodiments, the introducing and passing the NH₃-containing feed gas stream is performed at a weight hourly space velocity (WHSV) of about 5,000 to about 50,000 milliliters of the NH₃-containing feed gas stream per gram of the M-C catalyst per hour (mL g_{cat}⁻¹ h⁻¹).

In some embodiments, the reactor is selected from the group consisting of a membrane reactor, a fixed-bed reactor, a trickle-bed reactor, a moving bed reactor, a rotating bed reactor, a fluidized bed reactor, and a slurry reactor.

In some embodiments, the reactor is a membrane reactor in the form of a cylindrical tubular reactor. In some embodiments, the membrane reactor includes a cylindrical body portion, a gas inlet, a residue gas outlet, a H₂ gas outlet a cylindrical membrane layer, and an air gap adjacent to the cylindrical membrane layer.

In some embodiments, the cylindrical membrane layer contains the M-C catalyst within the cylindrical body portion of the reactor.

In some embodiments, an average diameter of the cylindrical membrane layer is at least about 10% less than an average diameter of the cylindrical body portion.

In some embodiments, the air gap is in fluid communication with the H₂ gas outlet.

In some embodiments, the gas inlet is in fluid communication with a first end of the cylindrical body portion.

In some embodiments, the residue gas outlet is in fluid communication with a second end of the cylindrical body portion.

In some embodiments, the cylindrical membrane layer comprising the M-C catalyst in situ simultaneously decomposes NH₃ to H₂ and N₂, and at least partially separates H₂ from residue gas by rejecting NH₃ and N₂, allowing H₂ to pass through the cylindrical membrane layer.

In some embodiments, the conversion of ammonia to H₂ and N₂ is about 40 to about 99% based on an initial concentration of the NH₃ present in the NH₃-containing feed gas stream.

In some embodiments, the M-C catalyst is a carbon material supported ruthenium (Ru—C) catalyst. The method further includes preparing the Ru—C catalyst by mixing an oxidized carbon material and a Ru salt in a solvent, and sonicating to form a dispersion; adding a reducing agent to the dispersion and mixing to form a precursor product in the dispersion; adding acetone to the dispersion and mixing thereby precipitating the precursor product from the mixture in the form of a precipitate; recovering the precipitate; and heating the precursor product at a temperature of about 400 to about 1200° C. in an inert atmosphere to form the Ru—C catalyst.

In some embodiments, the oxidized carbon material is prepared from a carbon material selected from the group consisting of activated carbon, graphene, porous carbon, coal, carbon nanotubes (CNT), carbon black (CB), graphene nanoplatelets (GnP), and mixtures thereof.

In some embodiments, the dispersion further contains a salt selected from the group consisting of an iridium salt, a platinum salt, a nickel salt, a cobalt salt, an iron salt, a rhodium salt, a palladium salt, a molybdenum salt and mixtures thereof.

In some embodiments, the solvent is selected from the group consisting of N-methyl-2-pyrrolidone (NMP), dimethyl sulfoxide, N,N-dimethylformamide, acetone, ethyl acetate, tributyl citrate, diethyl succinate, triethyl citrate, dimethylacetamide and mixtures thereof.

In some embodiments, the reducing agent is selected from the group consisting of sodium borohydride (NaBH₄), lithium aluminum hydride (LiAlH₄), lithium borohydride (LiBH₄), hydrazine (N₂H₄), sodium hydroxide (NaOH), sodium amalgam (Na(Hg)), diborane (B₂H₆), sodium persulfate (Na₂S₂O₆), potassium iodide (KI), oxalic acid (H₂C₂O₄), formic acid (HCOOH), ascorbic acid (C₆H₈O₆), and zinc amalgam (Zn(Hg)), and mixtures thereof.

In some embodiments, the Ru—C catalyst has a surface area of about 50 to about 500 square meters per gram (m²/g).

In some embodiments, the oxidized carbon material is an acid treated carbon material. The method further includes preparing the acid treated carbon material by mixing a carbon material and an acid to form a mixture.

In some embodiments, the acid is selected from the group consisting of nitric acid (HNO₃), sulfuric acid (H₂SO₄), acetic acid (AcOH), phosphorus pentoxide (PPA/P₂O₅), hypochlorous acid (HClO), and mixtures thereof; and heating the mixture.

In some embodiments, the oxidized carbon material is a steam treated carbon material. The method further includes preparing the steam treated carbon material by introducing a water vapor into a quartz reactor containing a carbon material; and passing the water vapor through the quartz reactor to contact the water vapor with the carbon material at a temperature of about 500 to about 1000° C.

In some embodiments, the oxidized carbon material is a fluorinated carbon material. The method further includes preparing the fluorinated carbon material by mixing a fluorinating reagent, a carbon material in water, and sonicating to form a mixture; heating the mixture to form a crude product in the mixture; separating the crude product from the mixture by centrifugation; and washing the crude product with two or more solvents to form the fluorinated carbon material.

### BRIEF DESCRIPTION OF THE DRAWINGS

FIG. 1 is a diagrammatic illustration depicting sintering issues that can occur in a traditional NH₃ cracking process as compared to the method of the present disclosure without the formation of sintered catalyst particles, according to certain embodiments of the present disclosure.

FIG. 2 is a diagrammatic illustration depicting carbon material supported metal (M-C) catalysts of the present disclosure in different shapes and forms, according to certain embodiments of the present disclosure.

FIG. 3 depicts thermogravimetric analysis (TGA) curves of carbon nanotubes (CNT) samples including raw, and case 1 to case 3 prepared by acid treatment, according to certain embodiments of the present disclosure.

FIG. 4 is a diagrammatic illustration depicting a steam activation system for the preparation of a steam treated carbon material, according to certain embodiments of the present disclosure.

FIG. 5 is a diagrammatic illustration depicting the steam treated carbon material, according to certain embodiments of the present disclosure.

FIG. 6 is a diagrammatic illustration depicting a method of preparing a fluorinated carbon material from activated carbon, according to certain embodiments of the present disclosure.

FIG. 7 is a diagrammatic illustration depicting the fluorinated carbon and oxygenated carbon material prepared from the activated carbon, according to certain embodiments of the present disclosure.

FIG. 8 is a diagrammatic illustration depicting a method of making the carbon material supported metal (M-C) catalysts for ammonia decomposition, according to certain embodiments of the present disclosure.

FIG. 9A is a Transmission electron microscopy (TEM) image of a carbon material supported ruthenium (Ru—C) catalyst at a magnification of 20 nanometers (nm), according to certain embodiments of the present disclosure.

FIG. 9A is a TEM image of an untreated carbon nanotubes supported ruthenium (Ru—CNT, untreated) catalyst at a magnification of 20 nanometers (nm), according to certain embodiments of the present disclosure.

FIG. 9B is a TEM image of a carbon black supported ruthenium (Ru—CB) catalyst at a magnification of 10 nm, according to certain embodiments of the present disclosure.

FIG. 9C is a TEM image of a graphene nanoplatelets supported ruthenium (Ru-GnP) catalyst at a magnification of 10 nm, according to certain embodiments of the present disclosure.

FIG. 9D is a TEM image of a carbon nanotubes supported ruthenium (Ru—CNT) catalyst at a magnification of 10 nm, according to certain embodiments of the present disclosure.

FIG. 10 is a diagrammatic illustration depicting the setup of an ammonia decomposition test, according to certain embodiments of the present disclosure.

FIG. 11 is a plotted graph depicting the effect of temperature on ammonia decomposition using various Ru—C catalysts, according to certain embodiments of the present disclosure.

FIG. 12 is a plotted graph depicting the effect of a promoter on ammonia decomposition using the Ru—CNT catalyst, according to certain embodiments of the present disclosure.

FIG. 13 is a plotted graph depicting the performance of Ru—CNT catalysts with different promoter loadings on ammonia decomposition, according to certain embodiments of the present disclosure.

FIG. 14 is a plotted graph depicting the performance of Ru—CNT catalysts with different Ru loadings on ammonia decomposition, according to certain embodiments of the present disclosure.

FIG. 15 is a plotted graph depicting the stability of the Ru—CNT catalyst with 2 wt. % of a promoter, according to certain embodiments of the present disclosure.

FIG. 16A shows X-ray diffraction (XRD) profiles of carbon nanotubes (CNT) before acid treatment, CNT after acid treatment, and the Ru—CNT catalyst, in a diffraction angle 2 theta (θ) range of 20° to 30°, according to certain embodiments of the present disclosure.

FIG. 16B shows XRD profiles of carbon nanotubes (CNT) before acid treatment, CNT after acid treatment, and the Ru—CNT catalyst, in a diffraction angle 2θ range of 10° to 70°, according to certain embodiments of the present disclosure.

FIG. 16C shows Fourier-transform infrared spectroscopy (FT-IR) spectrum of CNT before acid treatment and CNT after acid treatment, according to certain embodiments of the present disclosure.

FIG. 16D shows TGA and heat flow curves of CNT after acid treatment, according to certain embodiments of the present disclosure.

FIG. 17 shows an XRD profile of the Ru—CNT catalyst in a diffraction angle 2θ range of 10° to 90°, according to certain embodiments of the present disclosure.

FIG. 18 is a graph comparing Brunauer-Emmett-Teller (BET) nitrogen adsorption when heat treated with a residue of Na⁺ and when heat treated after the removal of Na⁺, according to certain embodiments of the present disclosure.

FIG. 19 is a graph comparing the ammonia decomposition performance of the sample heat-treated with Na⁺ and the ammonia decomposition performance of the sample heat-treated after Na⁺ removal, according to certain embodiments of the present disclosure.

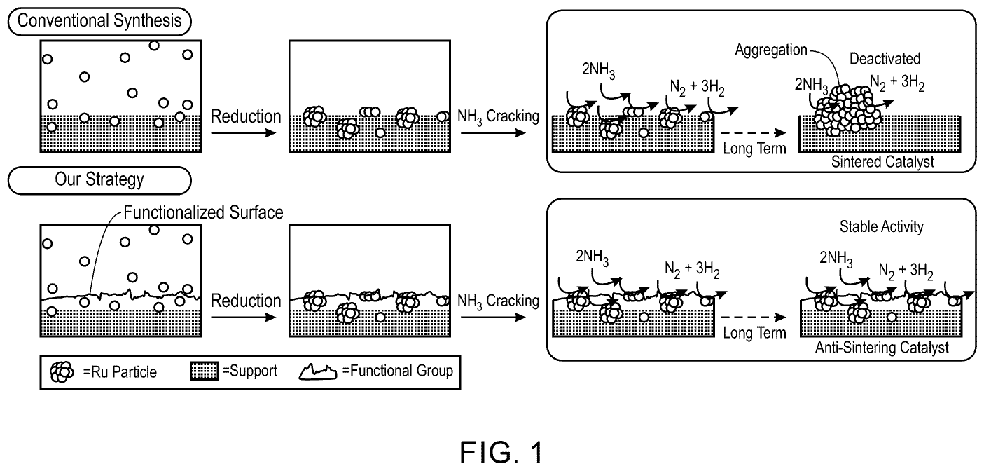

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the term “room temperature” and “ambient temperature” refer to a temperature in a range of 25 degrees Celsius (° C.)±3° C. in the present disclosure.

As used herein, the terms “particle size” and “pore size” are thought of as the lengths or longest dimensions of a particle and of a pore opening, respectively.

As used herein, the term “de-ionized water” refers to the water that has (most of) the ions removed.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, the term “uniform shape” refers to an average consistent shape that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

As used herein, the term “agglomerated particles” refers to an agglomeration of two or more individual M-C catalyst particles.

As used herein, the term “sintered particles” refers to M-C catalyst particles that have a reduction in active surface area.

As used herein, the term “inert atmosphere” refers to a gaseous mixture that contains little or no oxygen and contains inert or non-reactive gases. An inert atmosphere includes, but is not limited to, nitrogen, argon, helium, or mixtures thereof.

As used herein, the term “reducing agent” is a substance that causes the reduction of another substance, while it itself is oxidized. Reduction refers to a gain of electron(s) by a chemical species, and oxidation refers to a loss of electron(s) by a chemical species.

As used herein, the term “substantially” refers to a great extent or degree, e.g., “substantially similar” in context would be used to describe one morphology of the regenerated M-C catalyst which is to great extent or degree similar to another morphology of the M-C catalyst, such as at least about 80%, at least about 85%, at least about 90%, at least about 95%, or at least about 99% similar to that described in the specification herein.

As used herein, the terms “substantially free,” or “substantially free of agglomerated particles and sintered particles” are meant that the regenerated M-C catalyst, is at least about 98%, such as at least about 98.5%, at least about 99%, at least about 99.5%, or at least about 100% free of agglomerated particles and sintered particles.

In the methods described in this disclosure, the heat source for heating the gas mixtures or precursors includes, but is not limited to, electrical heat, solar heat, microwave, plasma.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

In view of the forgoing, one objective of the present disclosure is to provide a method for decomposing NH₃ to H₂ and N₂. A second objective of the present disclosure is to provide methods for making carbon material supported ruthenium (Ru—C) catalysts. A third objective of the present disclosure is to provide methods for making an acid treated carbon material. A fourth objective of the present disclosure is to provide methods for making a steam treated carbon material. A fifth objective of the present disclosure is to provide methods for making a fluorinated carbon material.

Provided in the present disclosure is a method for decomposing ammonia (NH₃) to hydrogen (H₂) and nitrogen (N₂). The method of the present disclosure is effective in generating H₂ from NH₃ at relatively low temperatures using a carbon material supported metal (M-C) catalyst. Additionally, the present disclosure also includes a method of preparing the M-C catalyst through different carbon materials, resulting in enhanced surface areas and controlled morphologies, thereby making it suitable for large-scale production and manufacturing processes.

According to an aspect of the present disclosure, a method for decomposing NH₃ includes introducing a H₂-containing feed gas stream into a reactor containing a carbon material supported metal (M-C) catalyst. In some embodiments, the H₂ is present in the H₂-containing feed gas stream at a concentration of about 0.01 to about 20 volume percentage (vol. %), such as about 0.1 to about 18 vol. %, about 1 to about 16 vol. %, about 3 to about 14 vol. %, about 5 to about 12 vol. %, or about 7 to about 10 vol. %, based on the total volume of the H₂-containing feed gas stream. In further embodiments, the H₂-containing feed gas stream contains H₂ at a concentration of about vol. %, based on the total volume of the H₂-containing feed gas stream. In further embodiments, the H₂-containing feed gas stream contains H₂ at a concentration of about 5 vol. %, based on the total volume of the H₂-containing feed gas stream.

In some embodiments, the H₂-containing feed gas stream further includes an inert gas selected from the group consisting of nitrogen, argon, and helium. The concentration of the inert gas present in the H₂-containing feed gas stream is in a range of about 80 to about 99.99 vol. %, such as about 82 to about 99 vol. %, about 84 to about 96 vol. %, about 86 to about 94 vol. %, or about 88 to about 92 vol. % based on the total volume of the H₂-containing feed gas stream. In further embodiments, the concentration of the inert gas present in the H₂-containing feed gas stream is about 90 vol. % based on the total volume of the H₂-containing feed gas stream. In further embodiments, the concentration of the inert gas present in the H₂-containing feed gas stream is about 5 vol. % based on the total volume of the H₂-containing feed gas stream. In some embodiments, the volume ratio of the H₂ to the inert gas present in the H₂-containing feed gas stream is in a range of about 1:10 to about 1:200, such as about 1:20 to about 1:150, about 1:30 to about 1:100, about 1:40 to about 1:50, or about 1:50. In further embodiments the volume ratio of the H₂ to the inert gas present in the H₂-containing feed gas stream is about 1:9. In further embodiments the volume ratio of the H₂ to the inert gas present in the H₂-containing feed gas stream is about 1:19. In some embodiments, the introducing the H₂-containing feed gas stream is performed at a flow rate of about 10 to about 50 milliliters per minute (mL/min), such as about 12 to about 45 mL/min, about 14 to about 40 mL/min, about 16 to about 35 mL/min, about 18 to about mL/min, or about 20 to about 30 mL/min. In further embodiments, the H₂-containing feed gas stream is passed at a flow rate of about 30 mL/min.

In some embodiments, the inert gas is argon. In some embodiments, the concentration of the argon present in the H₂-containing feed gas stream is in a range of about 80 to about 99.99 vol. %, such as about 82 to about 99 vol. %, about 84 to about 96 vol. %, about 86 to about 94 vol. %, or about 88 to about 92 vol. %, based on the total volume of the H₂-containing feed gas stream. In further embodiments, the concentration of the argon present in the H₂-containing feed gas stream is about 90 vol. % based on the total volume of the H₂-containing feed gas stream. In further embodiments, the concentration of the argon present in the H₂-containing feed gas stream is about 5 vol. % based on the total volume of the H₂-containing feed gas stream. In some embodiments, the volume ratio of the H₂ to argon present in the H₂-containing feed gas stream is in a range of about 1:10 to about 1:200, such as about 1:20 to about 1:150, about 1:30 to about 1:100, about 1:40 to about 1:50, or about 1:50. In further embodiments, the volume ratio of the H₂ to argon present in the H₂-containing feed gas stream is about 1:9. In further embodiments, the volume ratio of the H₂ to argon present in the H₂-containing feed gas stream is about 1:19.

In some embodiments, the reactor is selected from the group consisting of a membrane reactor, a fixed-bed reactor, a trickle-bed reactor, a moving bed reactor, a rotating bed reactor, a fluidized bed reactor, and a slurry reactor. In some embodiments, the reactor is a membrane reactor in the form of a cylindrical tubular reactor. In some embodiments, the membrane reactor includes a cylindrical body portion, an air gap, a cylindrical membrane layer, a gas inlet, a residue gas outlet, and a H₂ gas outlet. In some embodiments, the M-C catalyst is made in the form of the cylindrical membrane layer, and is placed within the cylindrical body portion of the reactor. The cylindrical membrane layer that includes the M-C catalyst can in situ simultaneously decompose NH₃ to H₂ and N₂, and at least partially separates H₂ from residue gas by rejecting NH₃ and N₂, and allows H₂ to pass through the cylindrical membrane layer. In some embodiments, the cylindrical membrane layer is about 1/20 to ½ of a total vertical height of the cylindrical body portion, such as about 1/16 to about 1:4, about 1/12 to about 1:6, or about 1:8 of the total vertical height of the cylindrical body portion. In some embodiments, an average diameter of the cylindrical membrane layer is at least about 10% less than an average diameter of the cylindrical body portion, such as at least about 15% less, at least about 20% less, at least about 25% less, at least about 30% less, or at least about 40% less than the average diameter of the cylindrical body portion. In some embodiments, the air gap is adjacent to the cylindrical membrane layer. In some embodiments, the air gap is in fluid communication with the H₂ gas outlet. In some embodiments, the gas inlet is in fluid communication with a first end of the cylindrical body portion. The gas inlet is also in fluid communication with a NH₃ source. In some embodiments, the residue gas outlet is in fluid communication with a second end of the cylindrical body portion. The residue gas outlet is also in fluid communication with a storage tank.

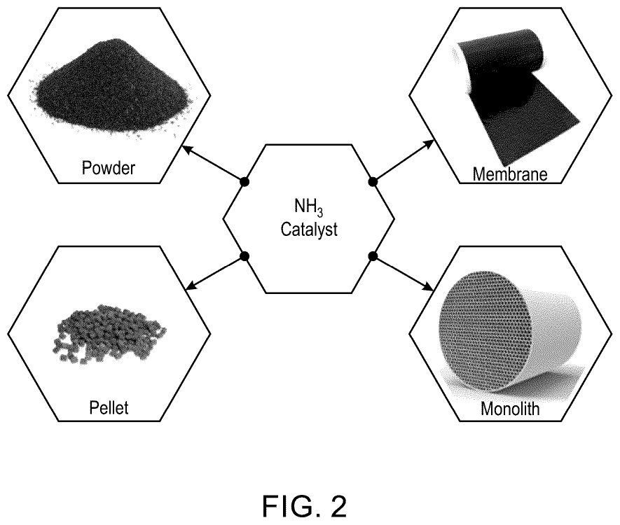

In some embodiments, the M-C catalyst is made in a form selected from the group consisting of powders, pellets, a membrane, a monolithic structure, and combinations thereof. FIG. 2 illustrates carbon material supported metal (M-C) catalysts of the present disclosure in different shapes and forms. In some embodiments, the M-C catalyst is made in the form of powders having an average particle size of about 1 micrometer (μm) to 5 millimeters (mm), such as about 10 μm to about 3 mm, about 100 μm to about 1 mm, about 300 μm to about 800 μm, or about 500 μm. In some embodiments, the M-C catalyst is made in the form of pellets having an average particle size of about 3 mm to about 3 centimeters (cm), such as about 5 mm to about 2 cm, about 7 mm to about 1 cm, or about 8 mm. In some embodiments, the M-C catalyst is made in the form of a membrane having a pore size of about 100 nm to about 20 μm, such as about 300 nm to about 15 μm, about 500 nm to about 10 μm, about 700 nm to about 5 μm, or about 900 nm to about 1 μm. In some embodiments, the M-C catalyst is made in the form of a monolithic structure having a hole density of about 10 to 500 holes per square centimeter, such as about 30 to about 400 holes per square centimeter, about 50 to about 300 holes per square centimeter, about 80 to about 200 holes per square centimeter, or about 100 holes per square centimeter.

In some embodiments, the M-C catalyst includes a metal selected from the group consisting of ruthenium (Ru), iridium (Ir), platinum (Pt), nickel (Ni), cobalt (Co), iron (Fe), rhodium (Rh), palladium (Pd), Molybdenum (Mo), and mixtures thereof. In some embodiments, the metal is present in the M-C catalyst in an amount of about 0.1 to about 40 wt. % of the M-C catalyst, such as about 0.5 to about 35 wt. %, about 1 to 30 wt. %, about 3 to about 25 wt. %, about 5 to about 20 wt. %, about 7 to about 15 wt. %, or about 10 wt. % of the M-C catalyst. In some embodiments, the metal is present in the M-C catalyst in an amount of about 5 wt. %. In some embodiments, the metal is present in the M-C catalyst in an amount of about 10 wt. %. In some embodiments, the M-C catalyst further includes one or more alkali and alkaline earth metal selected from the group consisting of sodium (Na), potassium (K), rubidium (Rb), cesium (Cs), barium (Ba), calcium (Ca), magnesium (Mg), and mixtures thereof. In some embodiments, the one or more alkali and alkaline earth metal is present in the M-C catalyst in an amount of about 0.01 to about 20 wt. % of the M-C catalyst, such as about 0.1 to about 15 wt. %, about 0.5 to about 10 wt. %, about 1 to about 5 wt. %, about 1.5 to about 3 wt. %, or about 2 wt. % of the M-C catalyst. In some embodiments, the one or more alkali and alkaline earth metal is present in the M-C catalyst in an amount of about 1 wt. %. In some embodiments, the one or more alkali and alkaline earth metal is present in the M-C catalyst in an amount of about 2 wt. %. In some embodiments, the one or more alkali and alkaline earth metal is present in the M-C catalyst in an amount of about 3 wt. %. In some embodiments, the one or more alkali and alkaline earth metal is present in the M-C catalyst in an amount of about 4 wt. %. In some embodiments, the one or more alkali and alkaline earth metal is present in the M-C catalyst in an amount of about 5 wt. %.

In some embodiments, the M-C catalyst contains ruthenium (Ru), and the M-C catalyst is a carbon material supported ruthenium (Ru—C) catalyst. In some embodiments, the Ru is present in the Ru—C catalyst in an amount of about 0.1 to about 40 wt. % of the Ru—C catalyst, such as about 0.5 to about 35 wt. %, about 1 to 30 wt. %, about 3 to about 25 wt. %, about 5 to about 20 wt. %, about 7 to about 15 wt. %, or about 10 wt. % of the Ru—C catalyst. In some embodiments, the Ru is present in the Ru—C catalyst in an amount of about 5 wt. %. In some embodiments, the Ru is present in the Ru—C catalyst in an amount of about 10 wt. %. In some embodiments, the Ru is present in the Ru—C catalyst in an amount of about 15 wt. %. In some embodiments, the Ru is present in the Ru—C catalyst in an amount of about 20 wt. %. In some embodiments, the Ru—C catalyst further includes K. In some embodiments, the K is present in the Ru—C catalyst in an amount of about 0.01 to about 20 wt. % of the M-C catalyst, such as about 0.1 to about 15 wt. %, about 0.5 to about 10 wt. %, about 1 to about 5 wt. %, about 1.5 to about 3 wt. %, or about 2 wt. % of the Ru—C catalyst. In some embodiments, the K is present in the Ru—C catalyst in an amount of about 1 wt. %. In some embodiments, the K is present in the Ru—C catalyst in an amount of about 2 wt. %. In some embodiments, the K is present in the Ru—C catalyst in an amount of about 3 wt. %. In some embodiments, the K is present in the Ru—C catalyst in an amount of about 4 wt. %. In some embodiments, the K is present in the Ru—C catalyst in an amount of about 5 wt. %.

In some embodiments, the M-C catalyst includes particles having an average particle size of about 0.5 to 10 nm, such as about 1 to about 8 nm, about 1.5 to about 6 nm, about 2 to about 4 nm, or about 3 nm. In some embodiments, the M-C catalyst includes particles having an average particle size of about 2.61 nm. In some embodiments, the M-C catalyst includes particles having an average particle size of about 3.15 nm. In some embodiments, the M-C catalyst includes particles having an average particle size of about 3.54 nm. In some embodiments, the M-C catalyst includes particles having an average particle size of about 5 nm. In some embodiments, the M-C catalyst is a Ru—C catalyst. In some embodiments, the Ru—C catalyst includes particles having an average particle size of about 0.5 to about 10 nm, such as about 1 to about 8 nm, about 1.5 to about 6 nm, about 2 to about 4 nm, or about 3 nm. In some embodiments, the Ru—C catalyst includes particles having an average particle size of about 2.61 nm. In some embodiments, the Ru—C catalyst includes particles having an average particle size of about 3.15 nm. In some embodiments, the Ru—C catalyst includes particles having an average particle size of about 3.54 nm.

In some embodiments, the M-C catalyst has a surface area of about 50 to 500 meters per gram (m²/g), such as about 100 to about 450 m²/g, about 150 to about 400 m²/g, about 200 to about 350 m²/g, or about 250 to about 300 m²/g. In some embodiments, the M-C catalyst has a surface area of about 401.03 m²/g. In some embodiments, the M-C catalyst has a surface area of about 105.94 m²/g. In some embodiments, the M-C catalyst has a surface area of about 237.40 m²/g. In some embodiments, the M-C catalyst is a Ru—C catalyst. In some embodiments, the Ru—C catalyst has a surface area of about 50 to 500 meters per gram (m²/g), such as about 100 to about 450 m²/g, about 150 to about 400 m²/g, about 200 to about 350 m²/g, or about 250 to about 300 m²/g. In some embodiments, the Ru—C catalyst has a surface area of about 401.03 m²/g. In some embodiments, the Ru—C catalyst has a surface area of about 105.94 m²/g. In some embodiments, the Ru—C catalyst has a surface area of about 237.40 m²/g.

The method for decomposing NH₃ further includes passing the H₂-containing feed gas stream through the reactor to contact the H₂-containing feed gas stream with the M-C catalyst at a temperature of about 400 to about 600° C., such as about 420 to about 580° C., about 440 to about 560° C., about 460 to about 540° C., about 480 to about 520° C., or about 500° C., to form a reduced M-C catalyst. In some embodiments, the H₂-containing feed gas stream is passed at a flow rate of about 10 to about 50 mL/min, such as about 12 to about 45 mL/min, about 14 to about 40 mL/min, about 16 to about 35 mL/min, about 18 to about 30 mL/min, or about 20 to about 30 mL/min. In further embodiments, the H₂-containing feed gas stream is passed at a flow rate of about 30 mL/min.

The method for decomposing NH₃ further includes introducing and passing an NH₃-containing feed gas stream through the reactor to contact the NH₃-containing feed gas stream with the reduced M-C catalyst at a temperature of about 200 to about 600° C., such as about 250 to about 550° C., about 300 to about 500° C., about 350 to about 450° C., or about 400° C., thereby converting at least a portion of the NH₃ to H₂ and N₂, regenerating the M-C catalyst to form a regenerated M-C catalyst, and producing a residue gas stream leaving the reactor. In some embodiments, the NH₃ is present in the NH₃-containing feed gas stream at a concentration of about 90 to about 99.99 vol. %, such as about 91 to about 99 vol. %, about 92 to about 98 vo. %, about 93 to 97 vol. %, about 94 to 96 vol. %, about 95 vol. % based on a total volume of the NH₃-containing feed gas stream. In some embodiments, the introducing and passing the NH₃-containing feed gas stream is performed at a flow rate of about 10 to about 200 mL/min., such as about 15 to about 150 mL/min, about 20 to about 100 mL/min, about 25 to about 50 mL/min, or about 30 mL/min. In some embodiments, the introducing and passing the NH₃-containing feed gas stream is performed at a weight hourly space velocity (WHSV) of about 5,000 to about 50,000 milliliters of the NH₃-containing feed gas stream per gram of the M-C catalyst per hour (mL g_{cat}⁻¹ h⁻¹), such as about 6,000 to about 40,000 mL g_{cat}⁻¹ h⁻¹, about 7,000 to about 30,000 mL g_{cat}⁻¹ h⁻¹, about 8,000 to about 20,000 mL g_{cat}⁻¹ h⁻¹, or about 9,000 to about 10,000 mL g_{cat}⁻¹ h⁻¹. In some embodiments, the introducing and passing the NH₃-containing feed gas stream is performed at a WHSV of about 9,000 mL g_{cat}⁻¹ h⁻¹.

In some embodiments, the residue gas stream leaving the reactor includes ammonia, nitrogen, inert gas, and hydrogen. H₂ is generated due to the reduction of ammonia to hydrogen by the M-C catalyst. In some embodiments, the conversion of ammonia to H₂ and N₂ is about 40 to about 99% based on an initial concentration of the NH₃ present in the NH₃-containing feed gas stream, such as about 45 to about 99.99%, about 50 to about 99%, about 55 to about 98%, about 60 to about 97%, about 65 to about 96%, about 70 to about 95%, about 75 to about 94%, about 80 to about 93%, about 85 to about 92%, or about 90% based on the initial concentration of the NH₃ present in the NH₃-containing feed gas stream. In some embodiments, the residue gas stream includes less than about 200 parts per billion (ppb) of ammonia, such as less than about 150 ppb, less than about 100 ppb, less than about 50 ppb, or less than about 10 ppb of ammonia. In some embodiments, the residue gas stream includes less than about 200 ppb of ammonia.

In some embodiments, the regenerated M-C catalyst is substantially free of agglomerated particles and sintered particles. In some embodiments, the regenerated M-C catalyst have substantially similar morphological and physiological characteristics as the M-C catalyst before the NH₃ decomposition. In some embodiments, the regenerated M-C catalyst includes particles having an average particle size of about 0.5 to 10 nm, such as about 1 to about 8 nm, about 1.5 to about 6 nm, about 2 to about 4 nm, or about 3 nm. In some embodiments, a difference between the average particle size of the M-C catalyst and the average particle size of the regenerated M-C catalyst is less than about 15%, such as less than about 10%, less than about 5%, or less than about 1%. In some embodiments, the regenerated M-C catalyst has a surface area of about 50 to 500 m²/g, such as about 100 to about 450 m²/g, about 150 to about 400 m²/g, about 200 to about 350 m²/g, or about 250 to about 300 m²/g. In some embodiments, a difference between the surface area of the M-C catalyst and the surface area of the regenerated M-C catalyst is less than about 15%, such as less than about 10%, less than about 5%, or less than about 1%.

The method for decomposing NH₃ further includes separating the H₂ from the residue gas stream to generate a H₂-containing product gas stream. In some embodiments, the separating the H₂ is performed by techniques including, but not limited to, pressure swing adsorption (PSA), membrane separation, cryogenic distillation, chemical reactions, and water-gas shift reaction.

In some embodiments, the separating is performed by introducing the residue gas stream into a hydrogen purification device including one or more hydrogen-selective membranes. Hydrogen purification device is configured to separate hydrogen from the residue gas stream and purifying the same. The hydrogen purification device may be a palladium membrane hydrogen purifier. The palladium membrane includes, but is not limited to, metallic tubes of palladium and silver alloy for allowing only monatomic hydrogen to pass through its crystal lattice when it is heated above about 300° C. The hydrogen-selective membranes are permeable to hydrogen gas but are at least substantially impermeable to other components in the residue gas stream. The plurality of hydrogen-selective membranes in the hydrogen purification device is arranged in parallel, and each membrane of the plurality of hydrogen-selective membranes is placed in a plane perpendicular to a direction of the gas mixture flow in the hydrogen purification device. The method for decomposing NH₃ may further include passing the residue gas stream through the plurality of hydrogen-selective membranes in the hydrogen purification device thereby allowing hydrogen gas to pass through the hydrogen-selective membrane and rejecting other components in the residue gas stream to form a residue composition. The method for decomposing NH₃ may further include collecting the hydrogen gas after passing and recycling the residue composition.

Also provided in the present disclosure are methods of making a carbon material supported ruthenium (Ru—C) catalyst. The method of making the Ru—C catalyst includes mixing an oxidized carbon material and a Ru salt in a solvent, and sonicating to form a dispersion. In some embodiments, the oxidized carbon material is prepared from a carbon material selected from the group consisting of activated carbon, graphene, porous carbon, coal, carbon nanotubes (CNT), carbon black (CB), graphene nanoplatelets (GnP), and mixtures thereof. In some embodiments, the oxidized carbon material is selected from the group consisting of an acid treated carbon material, a steam treated carbon material, and a fluorinated carbon material.

In some embodiments, the carbon material is carbon nanotubes. The carbon nanotubes may be any suitable carbon nanotubes known to one of ordinary skill in the art. Carbon nanotubes may be classified by structural properties such as the number of walls or the geometric configuration of the atoms that make up the nanotube. Classified by the number of walls, the carbon nanotubes can be single-walled carbon nanotubes (SWCNT) which have only one layer of carbon atoms arranged into a tube, or multi-walled carbon nanotubes (MWCNT), which have more than one single-layer tube of carbon atoms arranged so as to be nested, one tube inside another, each tube sharing a common orientation. Closely related to MWNTs are carbon nanoscrolls. Carbon nanoscrolls are structures similar in shape to a MWCNT, but made of a single layer of carbon atoms that has been rolled onto itself to form a multi-layered tube with a free outer edge on the exterior of the nanoscroll and a free inner edge on the interior of the scroll and open ends. The end-on view of a carbon nanoscroll has a spiral-like shape. For the purposes of this disclosure, carbon nanoscrolls are considered a type of MWCNT. Classified by the geometric configuration of the atoms that make up the nanotube, carbon nanotubes can be described by a pair of integer indices n and m. The indices n and m denote the number of unit vectors along two directions in the honeycomb crystal lattice of a single layer of carbon atoms. If m=0, the nanotubes are called zigzag type nanotubes. If n=m, the nanotubes are called armchair type nanotubes. Otherwise, they are called chiral type nanotubes. In some embodiments, the carbon nanotubes are metallic. In some embodiments, the carbon nanotubes are semiconducting. In some embodiments, the carbon nanotubes are SWCNTs. In some embodiments, the carbon nanotubes are MWCNTs. In some embodiments, the carbon nanotubes are carbon nanoscrolls. In some embodiments, the carbon nanotubes are zigzag type nanotubes. In some embodiments, the carbon nanotubes are armchair type nanotubes. In some embodiments, the carbon nanotubes are chiral type nanotubes. In some embodiments, the particles of a carbon nanomaterial are a single type of particle as described herein. In this context, “a single type of particle” refers to particles of a single carbon nanomaterial, particles which have substantially the same shape, particles which have substantially the same size, or any combination of these.

In some embodiments, the Ru salt includes, but is not limited to, ruthenium sulfate, ruthenium acetate, ruthenium citrate, ruthenium iodide, ruthenium chloride, ruthenium perchlorate, ruthenium nitrate, ruthenium phosphate, ruthenium triflate, ruthenium bis(trifluoromethanesulfonyl)imide, ruthenium tetrafluoroborate, ruthenium bromide, hydrates thereof, or mixtures thereof. In some embodiments, the Ru salt is ruthenium chloride (RuCl₃). In some embodiments, the dispersion further includes an iridium salt, a platinum salt, a nickel salt, a cobalt salt, an iron salt, a rhodium salt, a palladium salt, a molybdenum salt, or mixtures thereof.

In some embodiments, the solvent is selected from the group consisting of N-methyl-2-pyrrolidone (NMP), dimethyl sulfoxide, N,N-dimethylformamide, acetone, ethyl acetate, tributyl citrate, diethyl succinate, triethyl citrate, dimethylacetamide, and mixtures thereof. In some embodiments, the solvent is NMP.

In some embodiments, the oxidized carbon material is present in the dispersion in an amount of about 1 to 10 milligrams per milliliter (mg/mL), such as about 2 to about 9 mg/mL, about 3 to about 8 mg/mL, about 4 to about 7 mg/mL, about 5 to about 6 mg/mL, or about 6 mg/mL. In some embodiments, the oxidized carbon material is present in the dispersion in an amount of about 6.4 mg/mL. In some embodiments, the Ru salt is present in the dispersion in an amount of about 0.1 to 2 mg/mL, such as about 0.2 to about 1.8 mg/mL, about 0.3 to about 1.6 mg/mL, about 0.4 to about 1.4 mg/mL, about 0.5 to about 1.2 mg/mL, about 0.6 to about 1.0 mg/mL, or about 0.8 mg/mL. In some embodiments, the Ru salt is present in the dispersion in a concentration of about 0.8 mg/mL. In some embodiments, a weight ratio of the oxidized carbon material to the Ru salt is about 20:1 to 1:1, such as about 18:1 to about 2:1, about 16:1 to about 3:1, about 14:1 to about 4:1, about 12:1 to about 5:1, about 10:1 to about 6:1, or about 8:1. In some embodiments, the weight ratio of the oxidized carbon material to the Ru salt is about 8:1.

In some embodiments, the oxidized carbon material is present in the form of particles. The particles can be any shape known to one of ordinary skill in the art. Examples of suitable shapes the oxidized carbon material particles include, but are not limited to, spheres, spheroids, lentoids, ovoids, solid polyhedra such as tetrahedra, cubes, octahedra, icosahedra, dodecahedra, rectangular prisms, triangular prisms (also known as nanotriangles), nanoplatelets, nanodisks, nanotubes, blocks, flakes, discs, granules, angular chunks, or combinations thereof.

In some embodiments, the oxidized carbon material particles have uniform shape. In one embodiment, the shape is uniform and at least about 90% of the oxidized carbon material particles are spherical or substantially circular, and less than about 10% are polygonal. In further embodiments, the oxidized carbon material particles have non-uniform shape. In one embodiment, the shape is non-uniform and less than about 90% of the oxidized carbon material particles are spherical or substantially circular, and greater than about 10% are polygonal.

In some embodiments, the sonicating is carried out in a bath sonicator set to a frequency of about 10 to about 100 kilohertz (kHz), such as about 15 to about 90 kHz, about 20 to about 80 kHz, about 25 to about 70 kHz, about 30 to about 60 kHz, about 35 to about 50 kHz, or about 40 kHz. In some embodiments, the sonicating is carried out for about 0.5 to about 24 hours, such as about 1 to about 16 hours, about 1.5 to about 12 hours, about 2 to about 8 hours, about 2.5 to about 4 hours, or about 3 hours.

The method of making the Ru—C catalyst also includes adding a reducing agent to the dispersion and mixing to form a precursor product in the dispersion. In some embodiments, the reducing agent is selected from the group consisting of sodium borohydride (NaBH₄), lithium aluminum hydride (LiAlH₄), lithium borohydride (LiBH₄), hydrazine (N₂H₄), sodium hydroxide (NaOH), sodium amalgam (Na(Hg)), diborane (B₂H₆), sodium persulfate (Na₂S₂O₆), potassium iodide (KI), oxalic acid (H₂C₂O₄), formic acid (HCOOH), ascorbic acid (C₆H₈O₆), and zinc amalgam (Zn(Hg)), and mixtures thereof. In some embodiments, the reducing agent is sodium borohydride. In some embodiments, the sodium borohydride is added in the form of a sodium borohydride solution containing about 1 to about 20 wt. % of sodium borohydride based on the total weight of the sodium borohydride solution, such as about 2 to about 18 wt. %, about 4 to about 16 wt. %, about 6 to about 14 wt. %, about 8 to about 12 wt. %, or about 10 wt. % based on the total weight of the sodium borohydride solution. In further embodiments, the sodium borohydride solution has a concentration of about 10 wt. %. In some embodiments, the sodium borohydride solution is a water solution. In some embodiments, the sodium borohydride solution is an acetonitrile solution.

In some embodiments, the mixing is carried out at a mixing speed of about 100 to about 2000 revolutions per minute (rpm), such as about 150 to about 1800 rpm, about 200 to about 1600 rpm, about 250 to about 1400 rpm, about 300 to about 1200 rpm, about 350 to about 1000 rpm, about 400 to about 800 rpm, or about 500 rpm. The mixing may be carried out manually or with the help of a stirrer. In further embodiments, the mixing is performed at room temperature.

The method of making the Ru—C catalyst also includes adding acetone to the dispersion and mixing thereby precipitating the precursor product from the mixture in the form of a precipitate, and recovering the precipitate. In some embodiments, the recovering is performed via centrifugation, filtration, evaporation, or by a method used or known in the art. The centrifugation of the mixture is performed at about 1000 to about 9000 rpm, such as about 2000 to about 8000 rpm, about 3000 to 7000 rpm, about 4000 to about 6000 rpm, or about 4500 rpm for about 10 to about 120 minutes, such as about 15 to about 60 minutes, about 20 to about 30 minutes, or about 20 minutes. In further embodiments, the precursor product from the recovering is dried at a temperature of about 60 to about 120° C., such as about 70 to about 110° C., about 80 to about 100° C., or about 90° C. for a period of about 12 to about 16 hours to remove any water molecules and volatile components in the crude product. In addition, the crude product may be dried in a heating device such as ovens, hot plates, heating mantles and tapes, oil baths, salt baths, sand baths, air baths, hot-tube furnaces, hot-air guns, and microwave ovens.

The method of making the Ru—C catalyst also includes heating the precursor product at a temperature of about 400 to about 1200° C. in an inert atmosphere to form the Ru—C catalyst. In some embodiments, the precursor product is heated a temperature of about 400 to about 1200° C., such as about 500 to about 1100° C., about 600 to about 1000° C., about 700 to about 900° C., or about 800° C.

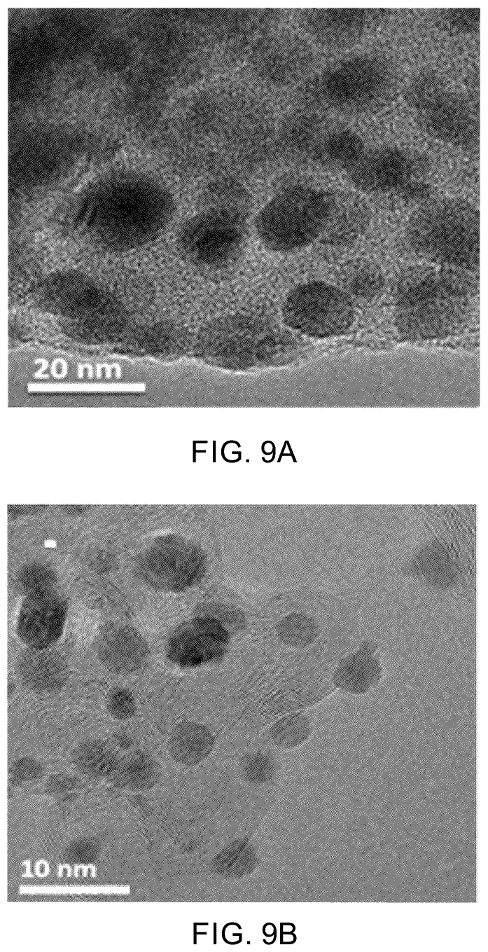

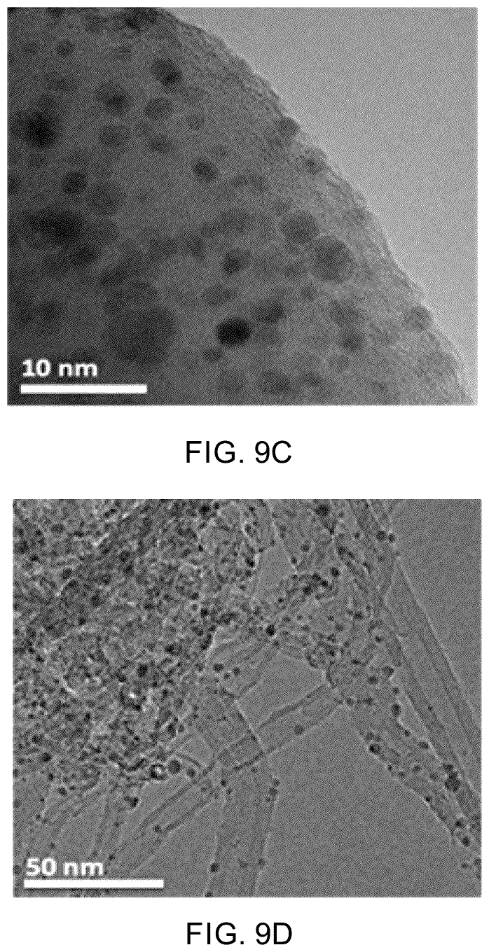

In some embodiments, the Ru—C catalyst has a surface area of about 50 to 500 meters per gram (m²/g), such as about 100 to about 450 m²/g, about 150 to about 400 m²/g, about 200 to about 350 m²/g, or about 250 to about 300 m²/g. In some embodiments, the Ru—C catalyst includes particles having an average particle size of about 0.5 to 10 nm, such as about 1 to about 8 nm, about 1.5 to about 6 nm, about 2 to about 4 nm, or about 3 nm, as depicted in FIGS. 9A to 9D.

Also provided in the present disclosure is a method of preparing an acid treated carbon material. The method of preparing the acid treated carbon material includes mixing a carbon material and an acid to form a mixture. In some embodiments, the carbon material selected from the group consisting of activated carbon, graphene, porous carbon, coal, carbon nanotubes (CNT), carbon black (CB), graphene nanoplatelets (GnP), and mixtures thereof. In some embodiments, the carbon material is CNT, CB, or GnP. In some embodiments, the acid is selected from the group consisting of nitric acid (HNO₃), sulfuric acid (H₂SO₄), acetic acid (AcOH), phosphorus pentoxide (PPA/P₂O₅), hypochlorous acid (HClO), and mixtures thereof. In some embodiments, the acid is HNO₃. In some embodiments, the acid is a mixed acid containing HNO₃ and H₂SO₄ in a molar ratio of about 2:1 to about 1:10, such as about 1:1 to about 1:8, about 1:2 to about 1:6, or about 1:3. In some embodiments, the acid is a mixed acid containing HNO₃ and H₂SO₄ in a molar ratio of about 1:3. In some embodiments, the acid is a mixed acid containing HNO₃ and H₂SO₄ in a volume ratio of about 2:1 to about 1:10, such as about 1:1 to about 1:8, about 1:2 to about 1:6, or about 1:3. In some embodiments, the acid is a mixed acid containing HNO₃ and H₂SO₄ in a volume ratio of about 1:3. In some embodiments, the carbon material is present in the mixture in an amount of about 5 mg/mL to about 50 mg/mL, such as about 10 to about 40 mg/mL, about 15 to about 30 mg/mL, about 20 to about 25 mg/mL, or about 20 mg/mL. In further embodiments, the carbon material is present in the mixture in an amount of about 20 mg/mL.

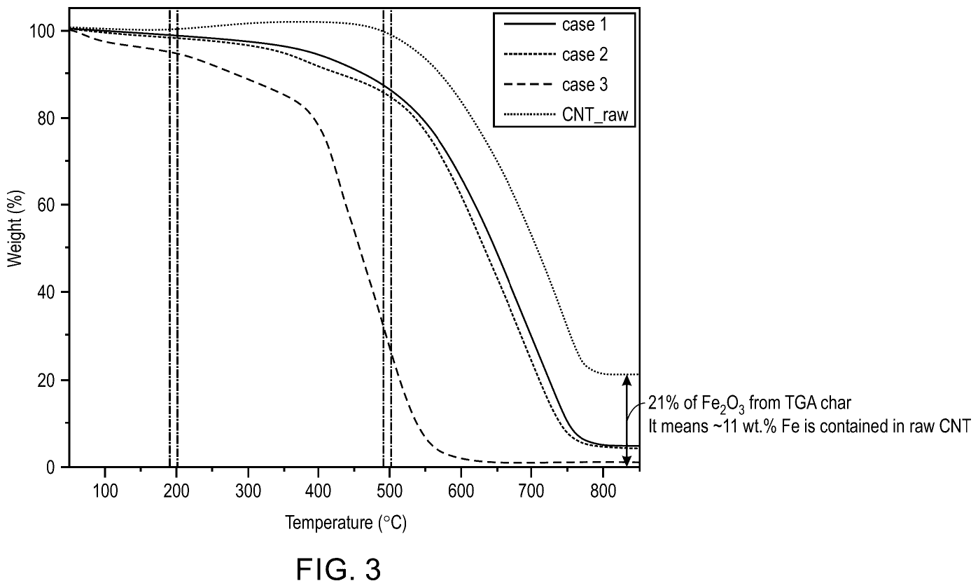

The method of preparing the acid treated carbon material also includes heating the mixture at a temperature of about 30 to about 150° C., such as about 50 to about 140° C., about 70 to about 130° C., about 90 to about 120° C., or about 100° C. for a period of about 0.5 to about 36 hours, such as about 1 to about 24 hours, about 2 to about 12 hours, about 4 to about 8 hours, or about 6 hours. Referring to FIG. 3, the case 1 sample has a weight loss of about 5 to about 20 wt. %, such as about 8 to about 15 wt. %, or about 11 wt. % based on an initial weight of the case 1 sample at a temperature of about 500° C., as depicted by the TGA curves. The case 2 sample has a weight loss of about 5 to about 20 wt. %, such as about 9 to about 16 wt. %, or about 13 wt. % based on an initial weight of the case 2 sample at a temperature of about 500° C., as depicted by the TGA curves. The case 3 sample has a weight loss of about 60 to about 80 wt. %, such as about 65 to about 75 wt. %, or about 70 wt. % based on an initial weight of the case 3 sample at a temperature of about 500° C., as depicted by the TGA curves. The CNT raw sample has a weight loss of about 1 to about 5 wt. %, such as about 2 to about 4 wt. %, or about 3 wt. % based on an initial weight of the CNT raw sample at a temperature of about 500° C., as depicted by the TGA curves.

Also provided in the present disclosure is a method of preparing a steam treated carbon material. The method of making the steam treated carbon material includes introducing a water vapor into a quartz reactor containing a carbon material, and passing the water vapor through the quartz reactor to contact the water vapor with the carbon material at a temperature of about 500 to about 1000° C., such as about 550 to about 900° C., about 600 to about 800° C., about 650 to about 700° C., or about 700° C. In some embodiments, the water vapor is passed at a flow rate of about 1 to about 20 milliliters per minute (mL/min), such as about 2 to about 15 mL/min, about 3 to about 10 mL/min, about 4 to about 6 mL/min, or about 5 mL/min. In some embodiments, the water vapor includes water and argon in a volume ratio of about 1%, such as about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, or about 30%. In some embodiments, the carbon material selected from the group consisting of activated carbon, graphene, porous carbon, coal, carbon nanotubes (CNT), carbon black (CB), graphene nanoplatelets (GnP), and mixtures thereof. In some embodiments, the carbon material is CNT, CB, or GnP.

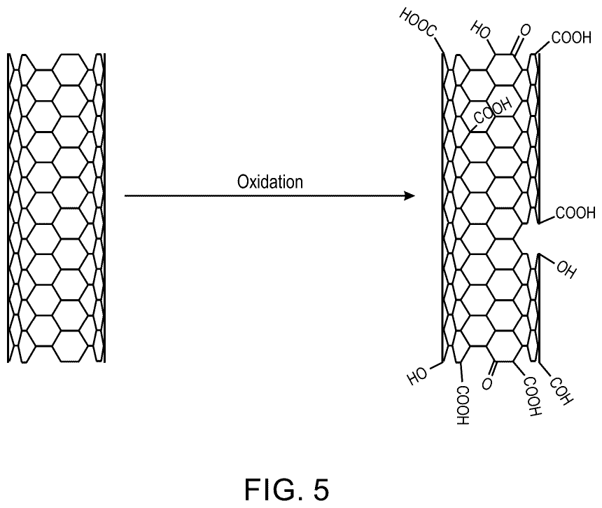

In some embodiments, the steam treated carbon material includes one or more functional moiety selected from the group consisting of aldehyde, lactone, carboxylic acid, carboxylic anhydride, phenol, ether, pyronic, pyrone, ketone, quinone, and epoxy, as depicted in FIG. 5. In some embodiments, the one or more functional moiety is a reactive site on surfaces of the steam treated carbon material for selective attachment to metal ions.

Also provided in the present disclosure is a method of preparing a fluorinated carbon material. The method of making the fluorinated carbon material includes mixing a fluorinating reagent, a carbon material in water, and sonicating to form a mixture. In some embodiments, the fluorinating reagent is present in the mixture in an amount of about 0.02 to about 0.5 millimoles per milliliter (mmol/mL), such as about 0.04 to 0.4 mmol/mL, about 0.06 to 0.3 mmol/mL, about 0.08 to 0.2 mmol/mL, or about 0.11 mmol/mL. In further embodiments, the fluorinating reagent is present in the mixture in an amount of about 0.11 mmol/mL. In some embodiments, the fluorinating reagent is an ammonium fluoride containing compound. In further embodiments, the fluorinating reagent is 1-(chloromethyl)-4-fluoro-1,4-diazoniabicyclo[2.2.2]octane ditetrafluoroborate (Selectfluor). In some embodiments, the Selectfluor is present in the mixture in an amount of about 0.02 to about 0.5 mmol/mL, such as about 0.04 to 0.4 mmol/mL, about 0.06 to 0.3 mmol/mL, about 0.08 to 0.2 mmol/mL, or about 0.11 mmol/mL. In further embodiments, the Selectfluor is present in the mixture in an amount of about 0.11 mmol/mL. In some embodiments, the carbon material selected from the group consisting of activated carbon, graphene, porous carbon, coal, carbon nanotubes (CNT), carbon black (CB), graphene nanoplatelets (GnP), and mixtures thereof. In some embodiments, the carbon material is CNT, CB, or GnP. In some embodiments, the carbon material is present in the mixture in an amount of about 2 to about 20 mg/mL, such as about 4 to about 16 mg/mL, about 6 to about 12 mg/mL, or about 8 mg/mL. In further embodiments, the carbon material is present in the mixture in an amount of about 8 mg/mL. In some embodiments, the carbon material is CB. In further embodiments, the CB is present in the mixture in an amount of about 2 to about 20 mg/mL, such as about 4 to about 16 mg/mL, about 6 to about 12 mg/mL, or about 8 mg/mL. In further embodiments, the CB is present in the mixture in an amount of about 8 mg/mL.

In some embodiments, the sonicating is carried out in a bath sonicator set to a frequency of about 10 to about 100 kHz, such as about 15 to about 90 kHz, about 20 to about 80 kHz, about 25 to about 70 kHz, about 30 to about 60 kHz, about 35 to about 50 kHz, or about 40 kHz. In some embodiments, the sonicating is carried out for about 0.1 to about 12 hours, such as about 0.3 to about 8 hours, about 0.5 to about 4 hours, about 0.7 to about 2 hours, about 0.9 to about 1 hours, or about 1 hour.

The method of making the fluorinated carbon material also includes heating the mixture to form a crude product in the mixture. In some embodiments, the mixture is heated at a temperature of about 30 to about 90° C., such as about 40 to about 80° C., about 50 to about 70° C., or about 60° C. for about 4 to about 96 hours, such as about 12 to about 72 hours, about 18 to about 64 hours, about 24 to about 56 hours, about 32 to about 48 hours, or about 48 hours. In some embodiments, the mixture is heated at a temperature of about 60° C. for about 6 hours.

The method of making the fluorinated carbon material also includes separating the crude product from the mixture by centrifugation. In some embodiments, the centrifugation of the mixture is performed at about 1000 to about 9000 rpm, such as about 2000 to about 8000 rpm, about 3000 to 7000 rpm, about 4000 to about 6000 rpm, or about 4500 rpm for about 10 to about 120 minutes, such as about 15 to about 60 minutes, about 20 to about 30 minutes, or about 20 minutes.

The method of making the fluorinated carbon material also includes washing the crude product with two or more solvents to form the fluorinated carbon material. In some embodiments, the two or more solvents include, but are not limited to, a hydrochloric acid (HCl) water solution, an acetic acid water solution, water, a HCl methanol solution, an acetic acid methanol solution, and acetone.

In further embodiments, the HCl water solution contains about 0.01 to about 5 wt. % of HCl based on a total weight of the HCl water solution, such as about 0.03 to about 3 wt. %, about 0.05 to about 2 wt. %, about 0.07 to about 1 wt. %, about 0.09 to about 0.5 wt. %, about 0.1 wt. % of HCl based on the total weight of the HCl water solution. In further embodiments, the acetic acid water solution contains about 0.01 to about 5 wt. % of acetic acid based on a total weight of the acetic acid water solution, such as about 0.03 to about 3 wt. %, about 0.05 to about 2 wt. %, about 0.07 to about 1 wt. %, about 0.09 to about 0.5 wt. %, or about 0.1 wt. % of acetic acid based on the total weight of the acetic acid water solution. In further embodiments, the HCl methanol solution contains about 0.01 to about 5 wt. % of HCl based on a total weight of the acetic acid water solution, such as about 0.03 to about 3 wt. %, about 0.05 to about 2 wt. %, about 0.07 to about 1 wt. %, about 0.09 to about 0.5 wt. %, or about 0.1 wt. % of HCl based on the total weight of the HCl methanol solution. In further embodiments, the acetic acid methanol solution contains about 0.01 to about 5 wt. % of acetic acid based on a total weight of the acetic acid water solution, such as about 0.03 to about 3 wt. %, about 0.05 to about 2 wt. %, about 0.07 to about 1 wt. %, about 0.09 to about 0.5 wt. %, or about 0.1 wt. % of acetic acid based on the total weight of the acetic acid methanol solution.

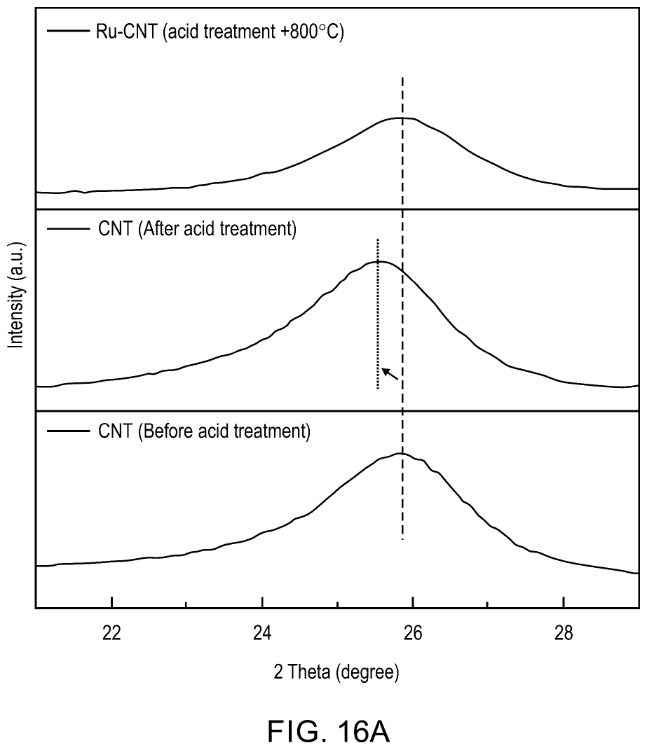

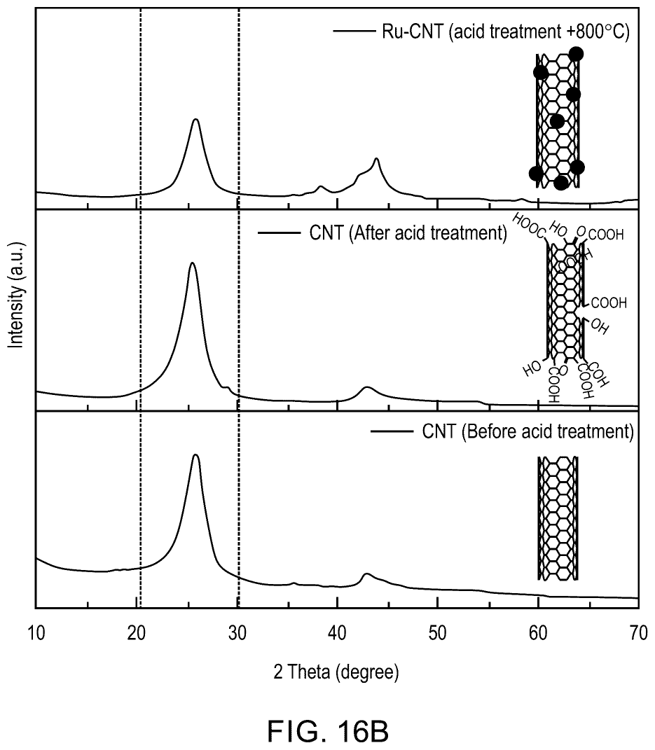

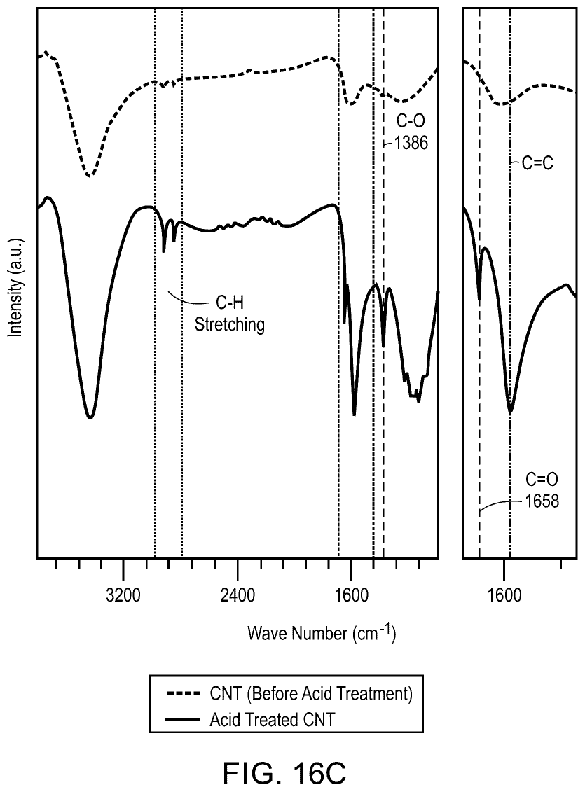

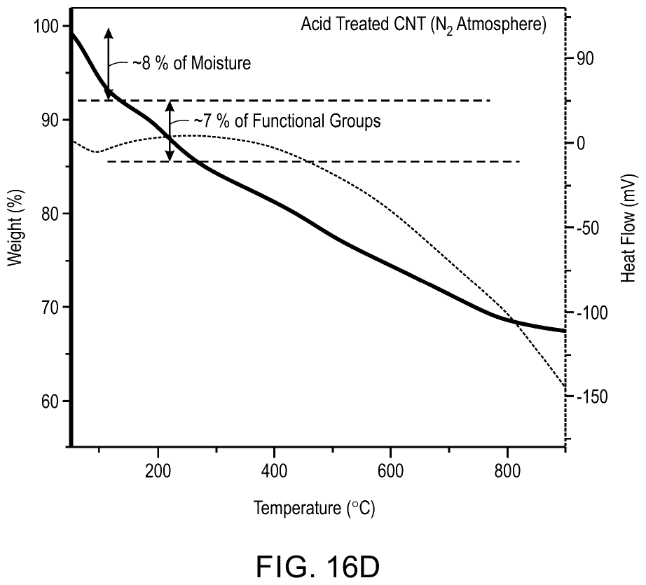

The crystalline structure of the carbon material and the oxidized carbon material is characterized by the Fourier transform infrared spectra (FTIR) as depicted in FIG. 16B. FTIR spectra of the carbon material and the oxidized carbon material is studied by using Fourier transform infrared spectra (Nicolet 170 IR spectrometer). For the Fourier transform infrared spectra characterization, the KBr discs of the samples are prepared by mixing and grounding the samples with KBr powder in mortar with pestle. The mixture is then shaped into discs under mechanical pressure. The sample discs are put into Fourier transform infrared spectra and spectral measurements are recorded in the wavenumber range of about 450 to about 4000 cm⁻¹. Prior to the above measurement, the samples are vacuum-dried at about 60° C. for a duration of about 24 hours.

In some embodiments, the carbon material has a first intense peak in a range of about 1286 to about 1486 cm⁻¹, such as about 1336 to about 1436 cm⁻¹, or about 1386 cm⁻¹; a second intense peak in a range of about 1558 to about 1758 cm⁻¹, such as about 1608 to about 1708 cm⁻¹, or about 1658 cm⁻¹; a third intense peak in a range of about 3400 to about 3600 cm⁻¹, such as about 3450 to about 3550 cm⁻¹, or about 3500 cm⁻¹.

In some embodiments, the oxidized carbon material has a first intense peak in a range of about 1220 to about 1420 cm⁻¹, such as about 1270 to about 1370 cm⁻¹, or about 1320 cm⁻¹; a second intense peak in a range of about 1500 to about 1700 cm⁻¹, such as about 1550 to about 1650 cm⁻¹, or about 1600 cm⁻¹; a third intense peak in a range of about 3400 to about 3600 cm⁻¹, such as about 3450 to about 3550 cm⁻¹, or about 3500 cm⁻¹.

The crystalline structure of the carbon material, the oxidized carbon material, and the M-C catalyst is characterized by X-ray diffraction (XRD). In some embodiments, the XRD patterns are collected in a Rigaku diffractometer (Miniflex) equipped with a Cu-Kα radiation source (λ=0.15406 nm) for a 2θ range extending between about 5° and about 90°, such as about 10° and about 80°, about 20° and about 70°, about 30° and about 60°, about 40° and about 50°, at an angular rate of about 0.005 to about 0.04°/s, about 0.01 to about 0.03°/s, or about 0.02°/s. In further embodiments, the XRD patterns are collected over a 2θ range extending between about 5° and about 90° at an angular rate of about 0.02°/s.

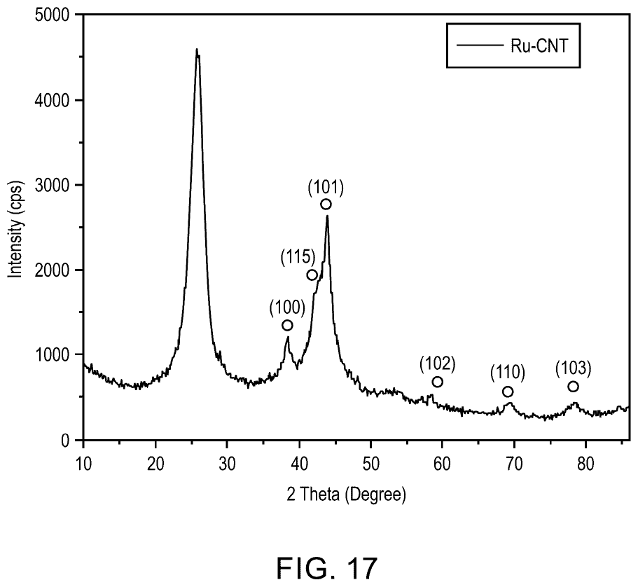

FIG. 17 depicts XRD patterns of the Ru—CNT catalyst prepared by acid treatment. In some embodiments, the Ru—CNT catalyst has a first intense peak with a 2 theta (θ) value in a range of about 20° to about 30°, such as about 23° to about 29°, or about 28°. In some embodiments the Ru—CNT catalyst has a second intense peak with a 2θ value in a range of about 35° to about 40°, such as about 37° to about 39°, or about 38° corresponding to the (100) lattice plane of the Ru-CNT catalyst structure. In some embodiments, the Ru—CNT catalyst has a third intense peak with a 2θ value in a range of about 40° to about 50°, such as about 42° to about 45°, or about 44° corresponding to the (115) and (101) lattice planes of the Ru—CNT catalyst structure. In some embodiments, the Ru—CNT catalyst has one or more intense peak with a 2θ value in a range of about 58° to about 80°, such as about 60° to about 70°, or about 68° corresponding to the (102), (110), and (103) lattice planes of the Ru—CNT catalyst structure.

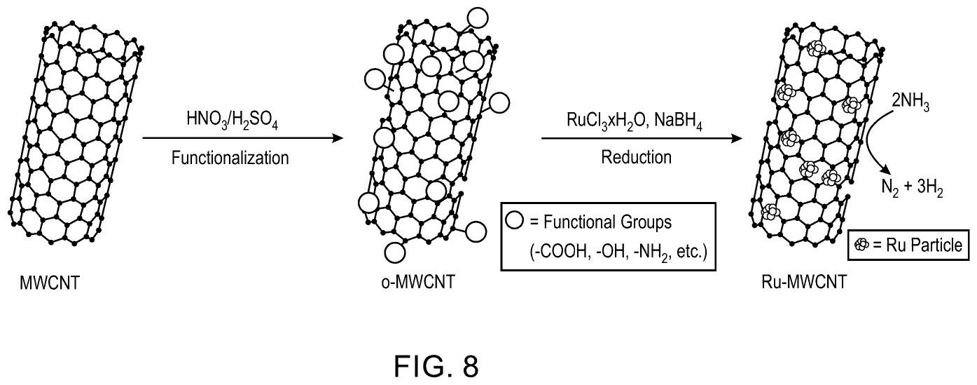

Referring to FIG. 8, the Ru—CNT catalyst prepared by acid treatment includes one or more functional moiety selected from the group consisting of aldehyde, carboxylic acid, amine, hydroxyl, ketone, and ether. In some embodiments, the one or more functional moiety of the Ru-CNT catalyst is selectively attached to a plurality of Ru ions.

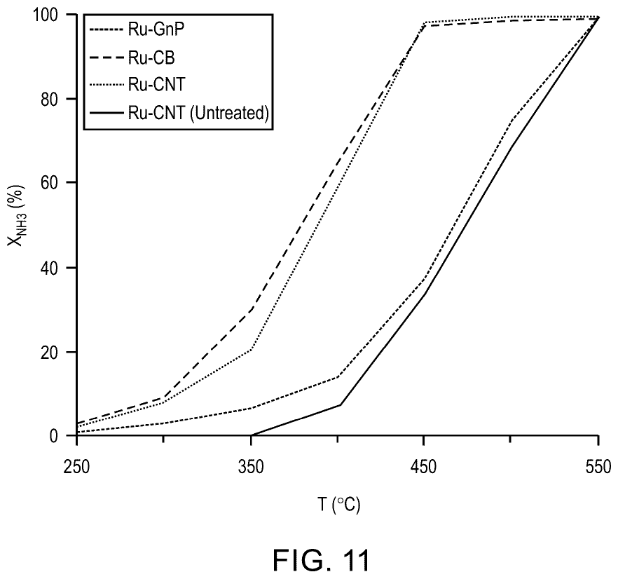

Referring to FIG. 11, the Ru—C catalyst includes, but is not limited to, an untreated carbon nanotubes supported ruthenium (Ru—CNT, untreated) catalyst, a carbon black supported ruthenium (Ru—CB) catalyst, a graphene nanoplatelets supported ruthenium (Ru-GnP) catalyst, and a carbon nanotubes supported ruthenium (Ru—CNT) catalyst. In some embodiments, each of the Ru—C catalyst includes about 5 to 15 wt. % of Ru based on a total weight of the Ru—C catalyst, such as about 6 to about 14 wt. %, about 7 to about 13 wt. %, about 8 to about 12 wt. %, about 9 to about 11 wt. %, or about 10 wt. % based on the total weight of the Ru—C catalyst. In some embodiments, each of the Ru—C catalyst includes about 10 wt. % of Ru. In some embodiments, the Ru—CB catalyst has an ammonia conversion of about 89 to about 99.9%, such as about 90 to about 99%, about 91 to about 98%, about 92 to about 97%, about 93 to about 96%, or about 94 to about 95% based on an initial NH₃ concentration of the NH₃-containing feed gas stream at a temperature of about 450° C. In some embodiments, the Ru—CNT catalyst has an ammonia conversion of about 89 to about 99.9%, such as about 90 to about 99%, about 91 to about 98%, about 92 to about 97%, about 93 to about 96%, or about 94 to about 95% based on an initial NH₃ concentration of the NH₃-containing feed gas stream at a temperature of about 450° C. In some embodiments, the Ru-GnP catalyst has an ammonia conversion of about 40 to about 50%, such as about 41 to about 49%, about 42 to about 48%, about 43 to about 47%, about 44 to about 46%, or about 45% based on an initial NH₃ concentration of the NH₃-containing feed gas stream at a temperature of about 450° C. In some embodiments, the Ru—CNT, untreated catalyst has an ammonia conversion of about 40 to about 50%, such as about 41 to about 49%, about 42 to about 48%, about 43 to about 47%, about 44 to about 46%, or about 45% based on an initial NH₃ concentration of the NH₃-containing feed gas stream at a temperature of about 450° C.

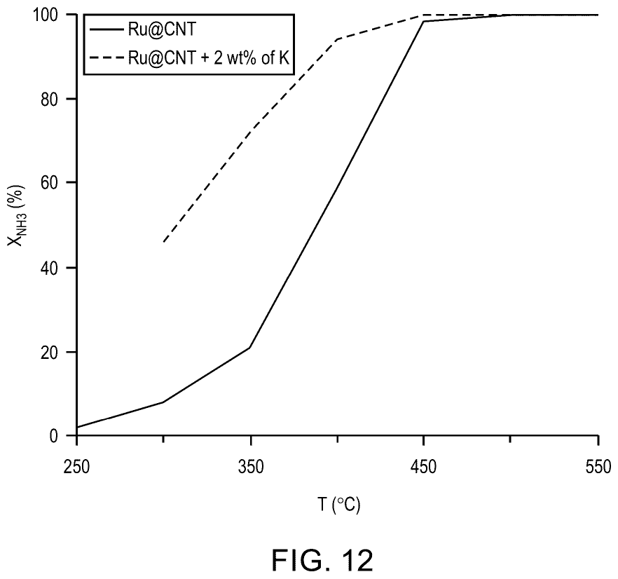

Referring to FIG. 12, the Ru—C catalyst includes, but is not limited to, a Ru—CNT catalyst, and a potassium (K) modified Ru—CNT catalyst. In some embodiments, the K modified Ru—CNT catalyst includes about 0.5 to 4 wt. % of K based on a total weight of the K modified Ru—CNT catalyst, such as about 1 to about 3 wt. %, about 1.5 to about 2.5 wt. %, or about 2 wt. % of K based on the total weight of the K modified Ru—CNT catalyst. In further embodiments, the K modified Ru—CNT catalyst includes about 2 wt. % of K based on the total weight of the K modified Ru—CNT catalyst. In some embodiments, the Ru—CNT catalyst has an ammonia conversion of about 20 to about 65%, such as about 25 to about 60%, about 30 to about 55%, about 35 to about 50%, about 40 to about 45%, or about 45% based on an initial NH₃ concentration of the NH₃-containing feed gas stream at a temperature of about 350 to about 400° C. In some embodiments, the K modified Ru—CNT catalyst has an ammonia conversion of about 65 to about 95%, such as about 70 to about 95%, about 80 to about 95%, about 80 to about 90%, about 85 to about 90%, or about 90% based on an initial NH₃ concentration of the NH₃-containing feed gas stream at a temperature of about 350 to about 400° C.

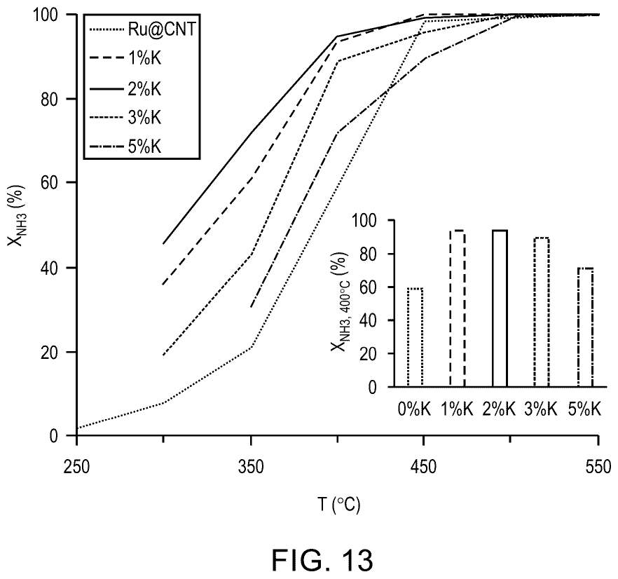

Referring to FIG. 13, the Ru—C catalyst includes, but is not limited to, a Ru—CNT catalyst, a 1 wt. % K modified Ru—CNT catalyst, a 2 wt. % K modified Ru—CNT catalyst, a 3 wt. % K modified Ru—CNT catalyst, and a 5 wt. % K modified Ru—CNT catalyst. In some embodiments, the Ru—CNT catalyst has an ammonia conversion of about 55 to about 65%, such as about 57 to about 63%, about 59 to about 61%, or about 60% based on an initial NH₃ concentration of the NH₃-containing feed gas stream at a temperature of about 400° C. In some embodiments, the 1 wt. % K modified Ru—CNT catalyst has an ammonia conversion of about 85 to about 99%, such as about 90 to about 98%, about 92 to about 97%, or about 95% based on an initial NH₃ concentration of the NH₃-containing feed gas stream at a temperature of about 400° C. In some embodiments, the 2 wt. % K modified Ru—CNT catalyst has an ammonia conversion of about 85 to about 99%, such as about 92 to about 98%, about 94 to about 98%, or about 98% based on an initial NH₃ concentration of the NH₃-containing feed gas stream at a temperature of about 400° C. In some embodiments, the 3 wt. % K modified Ru—CNT catalyst has an ammonia conversion of about 85 to about 99%, such as about 90 to about 98%, about 92 to about 97%, or about 95% based on an initial NH₃ concentration of the NH₃-containing feed gas stream at a temperature of about 400° C. In some embodiments, the 5 wt. % K modified Ru—CNT catalyst has an ammonia conversion of about 70 to about 80%, such as about 72 to about 78%, about 74 to about 76%, or about 75% based on an initial NH₃ concentration of the NH₃-containing feed gas stream at a temperature of about 400° C.

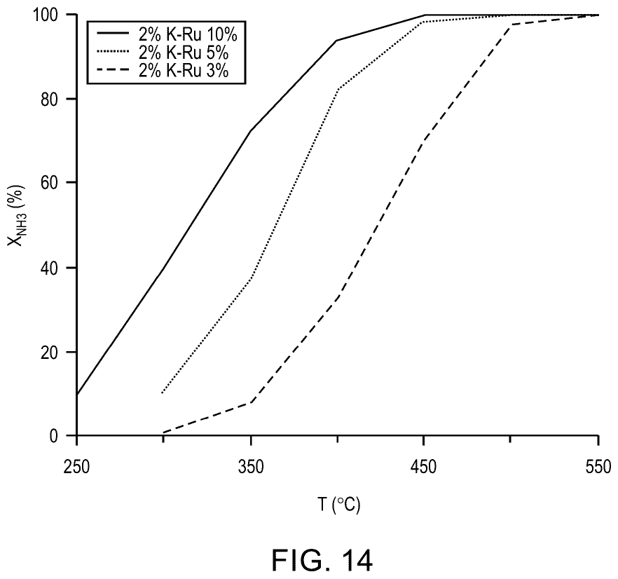

Referring to FIG. 14, the Ru—C catalyst includes, but is not limited to, a 2 wt. % K modified Ru—CNT catalyst containing about 3 wt. % of Ru (2% K—Ru 3% catalyst), a 2 wt. % K modified Ru—CNT catalyst containing about 5 wt. % of Ru (2% K—Ru 5% catalyst), a 2 wt. % K modified Ru—CNT catalyst containing about 10 wt. % of Ru (2% K—Ru 10% catalyst). In some embodiments, the 2% K—Ru 3% catalyst has an ammonia conversion of about 20 to about 40%, such as about 25 to about 37%, about 30 to about 34%, or about 32% based on an initial NH₃ concentration of the NH₃-containing feed gas stream at a temperature of about 400° C. In some embodiments, the 2% K—Ru 5% catalyst has an ammonia conversion of about 70 to about 85%, such as about 73 to about 83%, about 76 to about 81%, or about 81% based on an initial NH₃ concentration of the NH₃-containing feed gas stream at a temperature of about 400° C. In some embodiments, the 2% K—Ru 10% catalyst has an ammonia conversion of about 85 to about 95%, such as about 87 to about 93%, about 89 to about 93%, or about 93% based on an initial NH₃ concentration of the NH₃-containing feed gas stream at a temperature of about 400° C. In some embodiments, the 2% K—Ru 3% catalyst has an NH₃ decomposition rate of about 95,000 to about 115,000 milliliters per hour per gram of the Ru—C catalyst (mL h⁻¹ g⁻¹), such as about 98,000 to about 112,000 mL h⁻¹ g⁻¹, about 101,000 to about 109,000 mL h⁻¹ g⁻¹, about 104,000 to about 106,000 mL h⁻¹ g⁻¹, or about 105,000 mL h⁻¹ g⁻¹. In further embodiments, the 2% K—Ru 3% catalyst has an NH₃ decomposition rate of about 105,000 mL h⁻¹ g⁻¹. In some embodiments, the 2% K—Ru 5% catalyst has an NH₃ decomposition rate of about 137,000 to about 157,000 mL h⁻¹ g⁻¹, such as about 140,000 to about 154,000 mL h⁻¹ g⁻¹, about 143,000 to about 151,000 mL h⁻¹ g⁻¹, about 146,000 to about 148,000 mL h⁻¹ g⁻¹, or about 147,600 mL h⁻¹ g⁻¹. In further embodiments, the 2% K—Ru 5% catalyst has an NH₃ decomposition rate of about 147,600 mL h⁻¹ g⁻¹. In some embodiments, the 2% K—Ru 10% catalyst has an NH₃ decomposition rate of about 72,000 to about 92,000 mL h⁻¹ g⁻¹, such as about 75,000 to about 89,000 mL h⁻¹ g⁻¹, about 78,000 to about 86,000 mL h⁻¹ g⁻¹, about 81,000 to about 83,000 mL h⁻¹ g⁻¹, or about 82,800 mL h⁻¹ g⁻¹. In further embodiments, the 2% K—Ru 10% catalyst has an NH₃ decomposition rate of about 82,800 mL h⁻¹ g⁻¹.

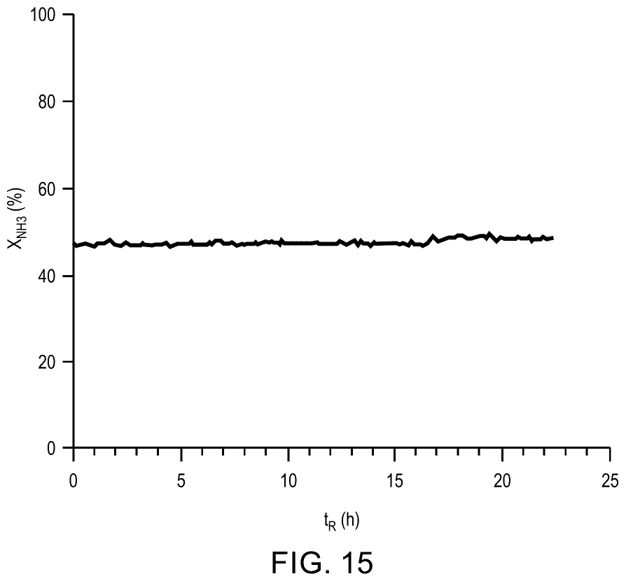

Referring to FIG. 15, the Ru—C catalyst is a 2 wt. % K modified Ru—CNT catalyst. In some embodiments, the 2 wt. % K modified Ru—CNT catalyst has an ammonia conversion of about 40 to about 60%, such as about 42 to about 56%, about 44 to about 52%, about 46 to about 48%, or about 46% based on an initial NH₃ concentration of the NH₃-containing feed gas stream at a temperature of about 300° C. for about 1 to 40 hours, such as about 5 to 35 hours, about 10 to 30 hours, about 15 to about 30 hours, about 20 to about 30 hours, or about 25 hours.

The M-C catalyst of the present disclosure enables ammonia decomposition at relatively low temperatures, such as 400° C. or lower, with improved energy efficiency. It also enables the clean dissociation of NH₃ at high conversion rates, ensuring efficient separation.

### EXAMPLES

The following examples demonstrate methods for decomposing ammonia (NH₃) to hydrogen (H₂) and nitrogen (N₂) using carbon material supported metal (M-C) catalysts, such as a carbon material supported ruthenium (Ru—C) catalyst, as described herein. The examples are provided solely for illustration and are not to be construed as limitations of the present disclosure, as many variations thereof are possible without departing from the spirit and scope of the present disclosure.

### Materials

Activated carbon, graphene, porous carbon, coal, carbon nanotubes (CNT) including both multi-walled carbon nanotubes (MWCNT) and single-walled carbon nanotubes (SWCNT), carbon black (CB), graphene nanoplatelets (GnP) were used as carbon materials. Nitric acid (HNO₃), sulfuric acid (H₂SO₄), acetic acid (AcOH), phosphorus pentoxide (PPA/P₂O₅), hypochlorous acid (HClO), Selectfluor (1-(chloromethyl)-4-fluoro-1,4-diazabicyclo(2.2.2)octane-1,4-diium ditetrafluoroborate), fluorine, hydrogen peroxide (H₂O₂), and steam were used as an oxidant. N-methyl-2-pyrrolidone (NMP), dimethyl sulfoxide, N,N-dimethylformamide, acetone, ethyl acetate, tributyl citrate, diethyl succinate, triethyl citrate, dimethylacetamide, glycol, methanol, and ethanol were used as a solvent in the preparation of the M-C catalyst. Ruthenium chloride (RuCl₃), iridium chloride (IrCl₃), platinum chloride, nickel chloride, cobalt chloride, iron chloride, rhodium chloride, palladium chloride, and molybdenum chloride were used as a metal salt. Sodium borohydride (NaBH₄), lithium aluminum hydride (LiAlH₄), lithium borohydride (LiBH₄), hydrazine (N₂H₄), sodium hydroxide (NaOH), sodium amalgam (Na(Hg)), diborane (B₂H₆), sodium persulfate (Na₂S₂O₆), potassium iodide (KI), oxalic acid (H₂C₂O₄), formic acid (HCOOH), ascorbic acid (C₆H₈O₆), and zinc amalgam (Zn(Hg)) were used as a reducing agent. Sodium hydroxide (NaOH), potassium hydroxide (KOH), rubidium hydroxide (RbOH), cesium hydroxide (CsOH), barium hydroxide (Ba(OH)₂), calcium hydroxide (Ca(OH)₂), magnesium hydroxide (Mg(OH)₂), sodium carbonate (Na₂CO₃), potassium carbonate (K₂CO₃), rubidium carbonate (Rb₂CO₃), cesium carbonate (Cs₂CO₃), barium carbonate (BaCO₃), calcium carbonate (CaCO₃), and magnesium carbonate (MgCO₃) were used as a promoter.

### Example 1: Preparation of an Acid Treated Carbon Material

The oxidation of carbon substrates was achieved using acids. At room temperature, about 10 g of a carbon material was added into a three-neck round bottom flask in an ice bath, or a cool water bath followed by the addition of about 500 mL of concentrated nitric acid (about 60 to 70 wt. %). The resulting mixture was sonicated for about 1 hour to disperse the carbon material in the nitric acid. The flask was transferred to an oil bath and refluxed at about 100 to about 120° C. for about 24 hours. For safety reasons, heating should proceed slowly at a rate of about 2° C./min. After cooling the reaction mixture to ambient conditions, the reaction mixture was poured into about 1 L of deionized water, and the acid treated carbon material was collected by filtration. The acid treated carbon material was then subjected to Soxhlet extraction with water and methanol to remove remaining acid and other impurities. Finally, the acid treated carbon material was freeze dried for about 3 days at about −120° C. under reduced pressure.

Depending on the solvent acidity, temperature and time were adjusted. For example, carbon material in HNO₃ (−1.5 pKa at 25° C.) was refluxed for 24 h but in the mixture of sulfuric acid (−10 pKa at 25° C.) and nitric acid at a volume ratio of about 1:3 was refluxed at a lower temperature of about 60° C.

As the refluxing of the reaction mixture proceeded, oxidation occurred on surfaces and pores of the carbon material and the defect in the carbon structure increased.

### Example 2: Preparation of a First Acid Treated Carbon Nanotubes (CNT) Material (Case 1)

Following the general preparation method described herein, a first acid treated CNT material (case 1) was prepared by adding about 10 g of carbon nanotubes into a three-neck round bottom flask in an ice bath followed by adding about 500 mL of concentrated nitric acid. The resulting mixture was sonicated for about 1 hour to disperse the carbon nanotubes in the nitric acid. The flask was transferred to an oil bath and refluxed at about 100° C. for about 24 hours. After cooling the reaction mixture to ambient conditions, the reaction mixture was poured into about 1 L of deionized water, and the case 1 sample was collected by filtration. The case 1 sample was then subjected to Soxhlet extraction with water and methanol to remove remaining acid and other impurities. Finally, the case 1 sample was freeze dried for about 3 days at about −120° C. under reduced pressure.

### Example 3: Preparation of a Second Acid Treated CNT Material (Case 2)

Following the general preparation method described herein, a second acid treated CNT material (case 2) was prepared by adding about 10 g of carbon nanotubes into a three-neck round bottom flask in an ice bath followed by adding about 500 mL of an acid mixture of concentrated nitric acid and concentrated sulfuric acid at a volume ratio of about 1:3. The resulting mixture was sonicated for about 1 hour to disperse the carbon nanotubes in the nitric acid. The flask was transferred to an oil bath and reacted at room temperature for about 1 hour. After cooling the reaction mixture to ambient conditions, the reaction mixture was poured into about 1 L of deionized water, and the case 2 sample was collected by filtration. The case 2 sample was then subjected to Soxhlet extraction with water and methanol to remove remaining acid and other impurities. Finally, the case 2 sample was freeze dried for about 3 days at about −120° C. under reduced pressure.

### Example 4: Preparation of a Third Acid Treated CNT Material (Case 3)

Following the general preparation method described herein, a third acid treated CNT material (case 3) was prepared by adding about 10 g of carbon nanotubes into a three-neck round bottom flask in an ice bath followed by adding about 500 mL of an acid mixture of concentrated nitric acid and concentrated sulfuric acid at a volume ratio of about 1:3. The resulting mixture was sonicated for about 1 hour to disperse the carbon nanotubes in the nitric acid. The flask was transferred to an oil bath and refluxed at about 100° C. for about 1 hour. After cooling the reaction mixture to ambient conditions, the reaction mixture was poured into about 1 L of deionized water, and the case 2 sample was collected by filtration. The case 2 sample was then subjected to Soxhlet extraction with water and methanol to remove remaining acid and other impurities. Finally, the case 2 sample was freeze dried for about 3 days at about −120° C. under reduced pressure.

### Example 5: Preparation of a Steam Treated Carbon Material

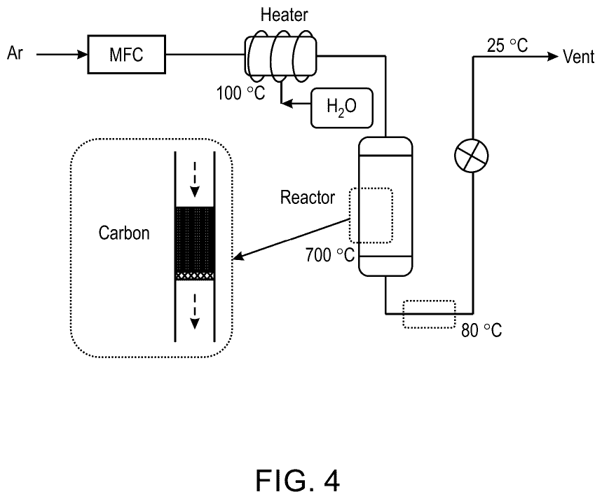

The oxidation of carbon substrates was also achieved using steam, as depicted in FIG. 4. About 250 mg of a carbon material was loaded in a quartz pipe having an inner diameter of about 11 mm. The steam was injected by syringe pump at a rate of about 0.16 mL/min, and an argon (Ar) flow was controlled by a mass flow controller. A combined Ar/steam mixture was introduced into the quartz pipe at a flow of about 5 mL/min. The carbon material was steam activated at a temperature of about 700° C. for about 2 hours, resulting in a product yield of about 50 to about 95%, as depicted in FIG. 4.

### Example 6: Preparation of a First Steam Treated Graphene Nanoplatelets (GnP) Material

Following the general preparation method described herein, a first steam treated graphene nanoplatelets (GnP) material was prepared by introducing 250 mg of graphene nanoplatelets into in a quartz pipe having an inner diameter of about 11 mm. The steam was injected by syringe pump at a rate of about 0.16 mL/min, and an argon (Ar) flow was controlled by a mass flow controller. A combined Ar/steam mixture was introduced into the quartz pipe at a flow of about 5 mL/min. The graphene nanoplatelets was steam activated at a temperature of about 700° C. for about 2 hours, resulting in a product yield of about 84%.

### Example 7: Preparation of a Second Steam Treated GnP Material

Following the general preparation method described herein, a second steam treated GnP material was prepared by introducing 250 mg of graphene nanoplatelets into in a quartz pipe having an inner diameter of about 11 mm. The steam was injected by syringe pump at a rate of about 0.16 mL/min, and an argon (Ar) flow was controlled by a mass flow controller. A combined Ar/steam mixture was introduced into the quartz pipe at a flow of about 5 mL/min. The graphene nanoplatelets was steam activated at a temperature of about 800° C. for about 2 hours, resulting in a product yield of about 65.2%.

### Example 8: Preparation of a Third Steam Treated GnP Material

Following the general preparation method described herein, a third steam treated GnP material was prepared by introducing 250 mg of graphene nanoplatelets into in a quartz pipe having an inner diameter of about 11 mm. The steam was injected by syringe pump at a rate of about 0.16 mL/min, and an argon (Ar) flow was controlled by a mass flow controller. A combined Ar/steam mixture was introduced into the quartz pipe at a flow of about 5 mL/min. The graphene nanoplatelets was steam activated at a temperature of about 900° C. for about 2 hours, resulting in a product yield of about 60%.

### Example 9: Preparation of a Fluorinated Carbon Material

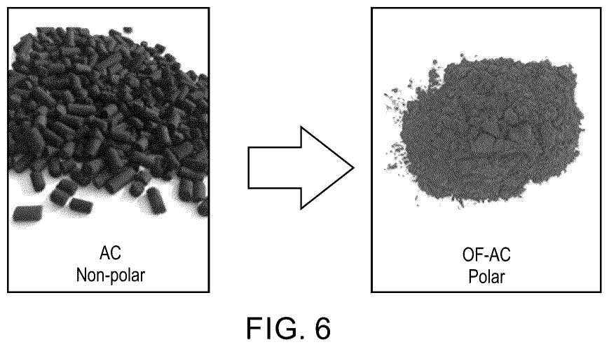

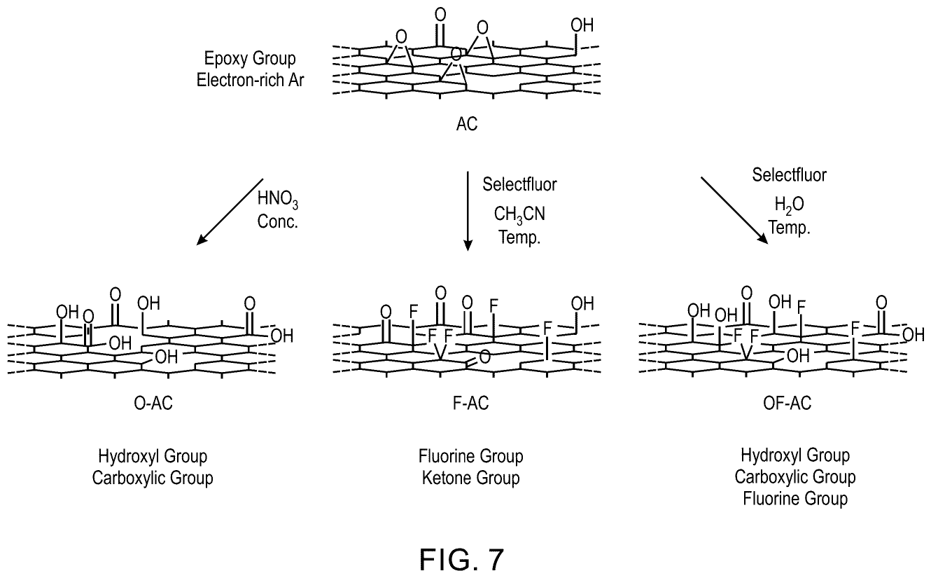

The oxidation of carbon substrates was also achieved via fluorination and hydrolysis as depicted in FIGS. 6 and 7. About 0.52 g (equivalent to about 1.388 mmol) of Selectfluor fluorinating reagent was dissolved in about 12 mL of distilled water in a Teflon vial. About 100 mg of a carbon material was added to the Teflon vial containing the Selectfluor solution. The resulting mixture in the Teflon vial was sealed with a rubber septum and sonicated for about 10 minutes, followed by stirring for about 48 hours in an oil bath at a temperature of about 60° C. After about 48 hours, the reaction mixture was cooled to room temperature, resulting in the formation of a solid. The solid was filtered and washed 3 times with 40 mL of dilute HCl (0.1% in water), 3 times with 40 mL of water, 3 times with 40 mL of dilute HCl (0.1% in methanol), 3 times with methanol and 2 times with 40 mL of acetone. Each washing step was done by soaking the solid in the corresponding solvent for about 10 minutes, followed by decanting the solvent after the solid had settled in the centrifuge. Washing was done to remove all adsorbed reactants and impurities. After washing, the solid was dried under vacuum at about 60° C. for about 6 hours.

### Example 10: Preparation of a First Fluorinated Carbon Black (CB) Material

Referring to FIG. 7, about 0.52 g (equivalent to about 1.388 mmol) of Selectfluor fluorinating reagent was dissolved in about 12 mL of distilled water in a Teflon vial. About 100 mg of carbon black was added to the Teflon vial containing the Selectfluor solution. The resulting mixture in the Teflon vial was sealed with a rubber septum and sonicated for about 10 minutes, followed by stirring for about 48 hours in an oil bath at a temperature of about 60° C. After about 48 hours, the reaction mixture was cooled to room temperature, resulting in the formation of a solid. The solid was filtered and washed 3 times with 40 mL of dilute HCl (0.1% in water), 3 times with 40 mL of water, 3 times with 40 mL of dilute HCl (0.1% in methanol), 3 times with methanol and 2 times with 40 mL of acetone. After washing, the first fluorinated CB material was dried under vacuum at about 60° C. for about 6 hours. Isolated mass of the first fluorinated CB material is about 91 mg, with a fluorine content of 8.45 wt. %.

### Example 11: Preparation of a Second Fluorinated Carbon Black (CB) Material

Referring to FIG. 7, about 0.52 g (equivalent to about 1.388 mmol) of Selectfluor fluorinating reagent was dissolved in about 12 mL of acetonitrile in a Teflon vial. About 100 mg of carbon black was added to the Teflon vial containing the Selectfluor solution. The resulting mixture in the Teflon vial was sealed with a rubber septum and sonicated for about 10 minutes, followed by stirring for about 48 hours in an oil bath at a temperature of about 60° C. After about 48 hours, the reaction mixture was cooled to room temperature, resulting in the formation of a solid. The solid was filtered and washed 3 times with 40 mL of dilute HCl (0.1% in water), 3 times with 40 mL of water, 3 times with 40 mL of dilute HCl (0.1% in methanol), 3 times with methanol and 2 times with 40 mL of acetone. After washing, the second fluorinated CB material was dried under vacuum at about 60° C. for about 6 hours.

### Example 12: Preparation of a Carbon Material Supported Metal (M-C) Catalyst

At room temperature, a calculated amount of an oxidized carbon material was taken in 150 mL of N-Methyl-2-Pyrrolidone (NMP) along with a calculated amount of a metal salt including, but not limited to, one or more Ru salt, one or more Ni salt, one or more Fe salt, and one or more Co salt. The resulting mixture was sonicated for about 3 hours in a bath sonicator. After sonication, the dispersed oxidized carbon material was stirred overnight using a magnetic stirrer, and the dispersion was again sonicated for about 2 hours to ensure complete dispersion of the oxidized carbon material in NMP. Then about 4 mL of sodium borohydride (10% solution in NMP) was added to the dispersion by dropping funnel under vigorous stirring; after the addition, the solution was stirred for about 1 hour (heating is not required). The dispersion was further mixed with 150 mL acetone, resulting in the formation of a precipitate. The precipitate was filtered, washed with water, and freeze-dried for about 3 days at about −120° C. under reduced pressure. After freeze-drying, the sample was annealed at different temperatures (such as 600, 700, 800, and 900° C.) under an Ar atmosphere for about 2 hours. The sample was washed with water after annealing to remove any unbound metal impurities in the matrix.

### Example 13: Preparation of a Carbon Nanotubes (CNT) Supported Ruthenium (Ru—C) Catalyst

Referring to FIG. 8 and following the general preparation method described herein, about 1 g of untreated (raw) carbon nanotubes was taken in 150 mL of NMP along with about 125 mg of ruthenium chloride (RuCl₃). The resulting mixture was sonicated for about 3 hours in a bath sonicator. After sonication, the dispersed untreated carbon nanotubes were stirred overnight using a magnetic stirrer, and the dispersion was again sonicated for about 2 hours to ensure complete dispersion of the untreated carbon nanotubes in NMP. Then about 4 mL of sodium borohydride (10% solution in NMP) was added to the dispersion by dropping funnel under vigorous stirring; after the addition, the solution was stirred for about 1 hour (heating is not required). The dispersion was further mixed with 150 mL acetone, resulting in the formation of a precipitate. The precipitate was filtered, washed with water, and freeze-dried for about 3 days at about −120° C. under reduced pressure. After freeze-drying, the sample was annealed at different temperatures (such as 600, 700, 800, and 900° C.) under an Ar atmosphere for about 2 hours. The untreated CNT supported ruthenium catalyst was washed with water after annealing to remove any unbound metal impurities in the matrix.

### Example 14: Preparation of an Oxidized CNT Supported Ruthenium Catalyst

Referring to FIG. 8 and following the general preparation method described herein, about 1 g of oxidized CNT was taken in 150 mL of NMP along with about 125 mg of RuCl₃. The resulting mixture was sonicated for about 3 hours in a bath sonicator. After sonication, the dispersed oxidized CNT were stirred overnight using a magnetic stirrer, and the dispersion was again sonicated for about 2 hours to ensure complete dispersion of the oxidized CNT in NMP. Then about 4 mL of sodium borohydride (10% solution in NMP) was added to the dispersion by dropping funnel under vigorous stirring; after the addition, the solution was stirred for about 1 hour (heating is not required). The dispersion was further mixed with 150 mL acetone, resulting in the formation of a precipitate. The precipitate was filtered, washed with water, and freeze-dried for about 3 days at about −120° C. under reduced pressure. After freeze-drying, the sample was annealed at different temperatures (such as 600, 700, 800, and 900° C.) under an Ar atmosphere for about 2 hours. The oxidized CNT supported ruthenium catalyst was washed with water after annealing to remove any unbound metal impurities in the matrix.

### Example 15: Preparation of an Oxidized GnP Supported Ruthenium Catalyst

Referring to FIG. 8 and following the general preparation method described herein, about 1 g of oxidized GnP was taken in 150 mL of NMP along with about 125 mg of RuCl₃. The resulting mixture was sonicated for about 3 hours in a bath sonicator. After sonication, the dispersed oxidized GnP were stirred overnight using a magnetic stirrer, and the dispersion was again sonicated for about 2 hours to ensure complete dispersion of the oxidized CNT in NMP. Then about 4 mL of sodium borohydride (10% solution in NMP) was added to the dispersion by dropping funnel under vigorous stirring; after the addition, the solution was stirred for about 1 hour (heating is not required). The dispersion was further mixed with 150 mL acetone, resulting in the formation of a precipitate. The precipitate was filtered, washed with water, and freeze-dried for about 3 days at about −120° C. under reduced pressure. After freeze-drying, the sample was annealed at different temperatures (such as 600, 700, 800, and 900° C.) under an Ar atmosphere for about 2 hours. The oxidized GnP supported ruthenium catalyst was washed with water after annealing to remove any unbound metal impurities in the matrix.

### Example 16: Preparation of an Oxidized CB Supported Ruthenium Catalyst

Referring to FIG. 8 and following the general preparation method described herein, about 1 g of oxidized CB was taken in 150 mL of NMP along with about 125 mg of RuCl₃. The resulting mixture was sonicated for about 3 hours in a bath sonicator. After sonication, the dispersed oxidized CB were stirred overnight using a magnetic stirrer, and the dispersion was again sonicated for about 2 hours to ensure complete dispersion of the oxidized CNT in NMP. Then about 4 mL of sodium borohydride (10% solution in NMP) was added to the dispersion by dropping funnel under vigorous stirring; after the addition, the solution was stirred for about 1 hour (heating is not required). The dispersion was further mixed with 150 mL acetone, resulting in the formation of a precipitate. The precipitate was filtered, washed with water, and freeze-dried for about 3 days at about −120° C. under reduced pressure. After freeze-drying, the sample was annealed at different temperatures (such as 600, 700, 800, and 900° C.) under an Ar atmosphere for about 2 hours. The oxidized CB supported ruthenium catalyst was washed with water after annealing to remove any unbound metal impurities in the matrix.

### Example 17: Preparation of a Promoter Modified M-C Catalyst

A potassium salt was introduced as a promoter into the M-C catalyst by using an impregnation method. The M-C catalyst was first dispersed in an ethanol solvent, following by addition of K₂CO₃ to achieve the target K loading ranging from 0 to 5 wt. %. After about 2 hours of stirring. The resulting mixture was filtered, and the solid residue was heated under Ar at a temperature of about 500° C. for about 3 hours.

### Example 18: Preparation of a Promoter Modified Ru—C Catalyst

A potassium salt was introduced as a promoter into an oxidized carbon material supported Ru catalyst by using the impregnation method. The Ru—C catalyst was first dispersed in an ethanol solvent, following by addition of K₂CO₃ to achieve the target K loading about 1 to 5 wt. %. After about 2 hours of stirring. The resulting mixture was filtered, and the solid residue was heated under Ar at a temperature of about 500° C. for about 3 hours.

### Example 19: Ammonia Decomposition Test

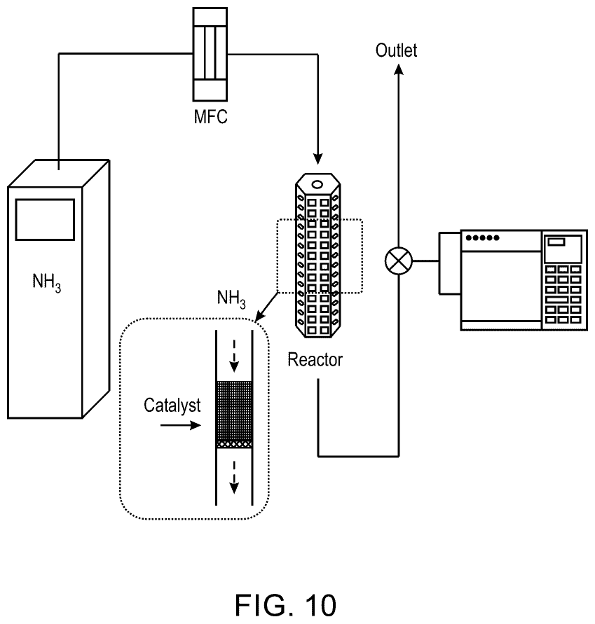

Ammonia decomposition catalytic tests were carried out in a PID Microactivity Reference system, using a continuous fixed bed stainless steel reactor coated with alumina to avoid any activity of the reactor, as depicted in FIG. 10. Prior to the activity measurement, the catalyst (about 200 mg pelletized between 300 mm and 500 mm and diluted with 1 g of SiC) was reduced/activated in situ with hydrogen (25 mL min⁻¹) at 500° C. for about 3 hours, using a ramp of about 5° C. min⁻¹. The catalytic performance was evaluated at different temperatures in the range 250-550° C. For the experiments at atmospheric pressure, ammonia in the gas phase (30-100 mL min⁻¹, WHSV=9000-36000 mL g_{cat}⁻¹ h⁻¹) was flown, using a mass flow controller, over the catalytic bed. Reaction products (N₂, H₂ and NH₃) were analyzed under isothermal conditions with an online gas chromatograph using helium (1 mL min⁻¹) as internal standard for quantitative analysis.

### Example 20: Shapes and Forms of the M-C Catalyst

The M-C catalyst of the present disclosure was made into different forms including, but not limited to, powers, pellets, membrane, and monolith, as depicted in FIG. 2.

### Example 21: Thermogravimetric Analysis (TGA)

Acid treated carbon materials, such as case 1, case 2, case 3, and case 4 (control, raw carbon nanotubes) were tested using TGA with a temperature ramp of about 10° C./min. Results are shown in FIG. 3. With respect to case 4, the raw carbon nanotubes have an iron (Fe) content of about 11 wt. % based on a total weight of the raw carbon nanotubes.

The raw carbon nanotubes after exposing to a temperature of up to 800° C. in the TGA test result in a formation of a char. The char has an iron oxide (Fe₂O₃) content of about 21 wt. % based on a total weight of the char.

### Example 22: Surface Chemistry

Referring to FIG. 5, the oxidized carbon material of the present disclosure has a surface containing functional groups including, but not limited to, aldehyde, lactone, carboxylic acid, carboxylic anhydride, phenol, ether, pyronic, pyrone, ketone, quinone, and epoxy.

### Example 23: Catalyst Characterization

FIG. 8 shows a schematic diagram of a method of making an acid treated carbon material supported metal catalysts for ammonia decomposition The carbon surface was oxidized through acid treatment, and functional groups such as —OH, —COOH, and —CHO, are attached to the oxidized part, which efficiently interact with metal ions to help the carbon structure hold metal. When heat treated, most of the functional groups are burned (carbonized), however due to the fact that the functional groups hold metal ions before heat treatment, preventing metal aggregation and resulting in the formation of nanoparticles.

Table 1. shows selected carbon material supported ruthenium catalysts prepared according to the methods of the present disclosure.

FIGS. 9A to 9D are TEM images of various carbon material supported ruthenium catalysts.

FIGS. 9A to 9D show the ruthenium particle image when prepared without acid treatment and the ruthenium-carbon catalysts images when prepared via acid treatment. Table 1. shows that the particle size is large when carbon material was not subjected to acid treatment, and that most of them have 5 nm or less when manufactured after acid treatment. The amount of Ru in catalysts are determined by TGA analysis (from residue of catalyst char (RuO₂).

In addition, when comparing CNTs according to the presence or absence of acid treatment, it can be seen that the surface area also increases because the functional groups reduce the inter-carbon interaction and make defects during acid treatment.

TABLE 1
Carbon material supported ruthenium catalysts.

| | Surface area | Ru | Avg. Particle size |
|---|---|---|---|
| | (m²/g) | (wt. %) | (nm) |
| Ru-CNT (Untreated) | 180.45 | 9.53 | 14.20 |
| Ru-GnP | 401.03 | 10.45 | 2.61 |
| Ru-CB | 105.94 | 10.52 | 3.15 |
| Ru-CNT | 237.40 | 10.18 | 3.54 |

### Example 24: Performance Test

FIG. 11 shows a graph of ammonia decomposition comparison according to the type of carbon structure. It was observed that all have similar ruthenium contents, but acid-treated CNTs and CBs show improved conversion rates, and CNTs without acid-treated (untreated Ru—CNT) show low performance. Since Ru nanoparticles are distributed in a size close to 4 nm, the results show high performance. However, the performance of Ru-GnP is low because graphic region occupies a larger part than other structures, resulting in a relatively large interlayer interaction, leaving Ru particles distributed at edges.

FIG. 12 is a graph showing improved ammonia decomposition performance using potassium as a promoter. Promoters capable of promoting ammonia decomposition catalysts such as Na, Cs, etc. (alkali metal) were tested.

FIG. 13 shows an effect of a promoter ratio on the catalyst performance. From this test, the amount of promoter ranges from 1 to 3 wt. %.

FIG. 14 shows an effect of a ruthenium content on the catalyst performance. Results are as shown in Table 2.

TABLE 2
NH₃ decomposition rate at 400° C.

| | NH₃ decomposition |
|---|---|
| Ru content (wt. %) | rate (mL h⁻¹ g⁻¹) at 400° C. |
| 10 | 82,800 |
| 5 | 147,600 |
| 3 | 105,000 |

FIG. 15 shows the stability of the catalyst prepared according to the present invention. It occurs well for 24 hours without degradation, which shows that structural collapse or agglomeration does not occur during the reaction. To test the conversion changes, the reaction temperature was kept at 300° C. to adjust it to around 50% conversion.

FIGS. 16A and 16B are XRD images showing changes in carbon nanotube (CNT) structures according to acid (nitric acid) and heat treatment (800° C., N₂). FIG. 17 shows XRD image of Ru—CNT (800° C., N₂), in which Ru (0) particles are marked with dots. From the XRD tests, d-spacing value increases as the carbon structure is destroyed by strong acid (solid line).

FIG. 16C is the FT-IR image before and after acid treatment of CNT, confirming the presence of functional groups in the catalysts. It can be seen that the carboxyl group increased after acid treatment as CNT became oxidized, which becomes a factor that increases binding interaction when metal (ruthenium) is supported. The carbon structure that has been acid-treated can be seen to recover while being carbonized again in the heat treatment process later (dot line).

FIG. 16D is TGA of acid-treated CNT measured in a N₂ atmosphere, illustrating the moisture content and how many functional groups are formed. After acid treatment, an increased amount of hydrophilic functional groups is observed with about 8% of moisture at a temperature of about 200° C. It can be observed that the functional group breaks off at about 7 percent of the total weight.

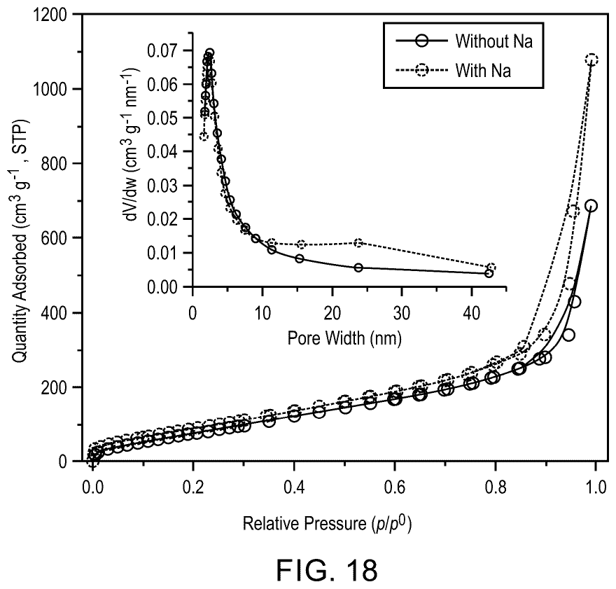

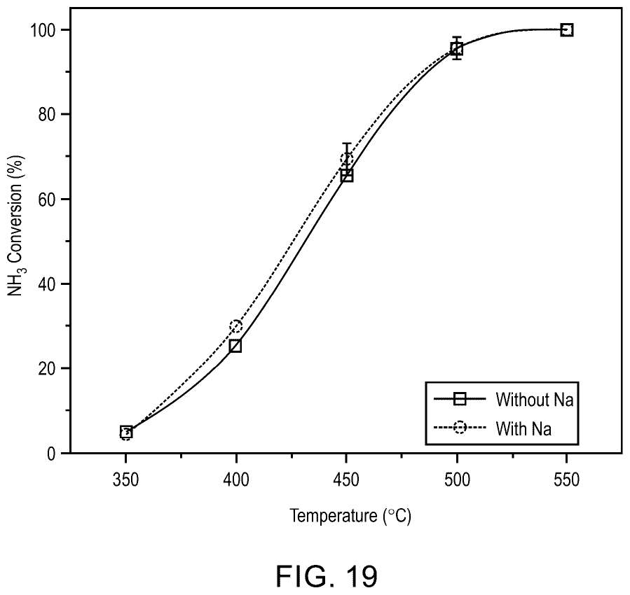

According to FIGS. 18 and 19, after reducing the Ru particles using NaBH₄ in the Ru—CNT procedure, the residue of Na+ can remain (adsorb) in the catalyst. A macropore-developed structure can be obtained by a direct heat treatment of the residue catalyst without washing, resulting in enhanced NH₃ cracking effect.

Additionally, the Ru contents in the Ru-carbon catalyst can be adjusted depending on the NH₃ decomposition conditions as depicted in Table 3. When a higher pressure was applied than normal pressure (1 bar), same effect can be obtained but at a lower temperature. In addition, when a reducing conditions, such as a gas containing about 5% of H₂, temperature can be reduced.

The present disclosure provides high activity catalysts at lower operating temperatures, such as 450° C. The active metal, such as Ru, spread out in nanoparticles over the carbon material support resulting in structured catalyst composites that are suitable to be integrated with membrane reactor type configurations. The carbon material supported metal catalyst has no sintering or agglomeration.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

### EMBODIMENTS

Embodiment 1: A method for decomposing ammonia (NH₃) to hydrogen (H₂) and nitrogen (N₂), the method comprising:
introducing a H₂-containing feed gas stream into a reactor comprising a carbon material supported metal (M-C) catalyst;
wherein the M-C catalyst comprises a metal selected from the group consisting of ruthenium (Ru), iridium (Ir), platinum (Pt), nickel (Ni), cobalt (Co), iron (Fe), rhodium (Rh), palladium (Pd), Molybdenum (Mo), and mixtures thereof;
passing the H₂-containing feed gas stream through the reactor to contact the H₂-containing feed gas stream with the M-C catalyst at a temperature of about 500° C. to form a reduced M-C catalyst;
introducing and passing an NH₃-containing feed gas stream through the reactor to contact the NH₃-containing feed gas stream with the reduced M-C catalyst at a temperature of about 200 to about 600° C. thereby converting at least a portion of the NH₃ to H₂ and N₂, regenerating the M-C catalyst to form a regenerated M-C catalyst, and producing a residue gas stream, wherein the regenerated M-C catalyst is substantially free of agglomerated particles and sintered particles; and
separating the H₂ from the residue gas stream to generate a H₂-containing product gas stream.

Embodiment 2: The method of embodiment 1, wherein the M-C catalyst is made in a form selected from the group consisting of powders, pellets, a membrane, a monolithic structure, and combinations thereof.

Embodiment 3: The method of embodiment 1 or 2, wherein the metal is present in the M-C catalyst in an amount of about 0.5 to about 30 wt. % of the M-C catalyst.

Embodiment 4: The method of any one of embodiments 1-3, wherein the M-C catalyst further comprises one or more alkali and alkaline earth metal selected from the group consisting of sodium (Na), potassium (K), rubidium (Rb), cesium (Cs), barium (Ba), calcium (Ca), magnesium (Mg), and mixtures thereof.

Embodiment 5: The method of any one of embodiments 1-4, wherein the one or more alkali and alkaline earth metal is present in the M-C catalyst in an amount of about 0.01 to about 8 wt. % of the M-C catalyst.

Embodiment 6: The method of any one of embodiments 1-5, wherein the H₂ is present in the H₂-containing feed gas stream at a concentration of about 0.01 to about 20 vol. % based on a total volume of the H₂-containing feed gas stream, and wherein the passing the H₂-containing feed gas stream is performed at a flow rate of about 10 to about 50 milliliters per minute (mL/min). The method of embodiments 1-6, wherein the NH₃ is present in the NH₃-Embodiment 7: containing feed gas stream at a concentration of about 90 to about 99.99 vol. % based on a total volume of the NH₃-containing feed gas stream, and wherein the introducing and passing the NH₃-containing feed gas stream is performed at a flow rate of about 10 to about 200 mL/min.

Embodiment 8: The method of embodiments 1-7, wherein the introducing and passing the NH₃-containing feed gas stream is performed at a weight hourly space velocity (WHSV) of about 5,000 to about 50,000 milliliters of the NH₃-containing feed gas stream per gram of the M-C catalyst per hour (mL g_{cat}⁻¹ h⁻¹).

Embodiment 9: The method of embodiments 1-8, wherein the reactor is selected from the group consisting of a membrane reactor, a fixed-bed reactor, a trickle-bed reactor, a moving bed reactor, a rotating bed reactor, a fluidized bed reactor, and a slurry reactor.

Embodiment 10: The method of embodiments 1-9, wherein the reactor is a membrane reactor in the form of a cylindrical tubular reactor comprising:
a cylindrical body portion;
a gas inlet;
a residue gas outlet;
a H₂ gas outlet;
a cylindrical membrane layer comprising the M-C catalyst within the cylindrical body portion of the reactor, wherein an average diameter of the cylindrical membrane layer is at least about 10% less than an average diameter of the cylindrical body portion;
an air gap adjacent to the cylindrical membrane layer;
wherein the air gap is in fluid communication with the H₂ gas outlet;
wherein the gas inlet is in fluid communication with a first end of the cylindrical body portion;
wherein the residue gas outlet is in fluid communication with a second end of the cylindrical body portion; and
wherein the cylindrical membrane layer comprising the M-C catalyst in situ simultaneously decomposes NH₃ to H₂ and N₂, and at least partially separates H₂ from residue gas by rejecting NH₃ and N₂, allowing H₂ to pass through the cylindrical membrane layer.

Embodiment 11: The method of embodiments 1-10, wherein the conversion of ammonia to H₂ and N₂ is about 40 to about 99% based on an initial concentration of the NH₃ present in the NH₃-containing feed gas stream.

Embodiment 12: The method of embodiments 1-11, wherein the M-C catalyst is a carbon material supported ruthenium (Ru—C) catalyst, and the method further comprises preparing the Ru—C catalyst by:
mixing an oxidized carbon material and a Ru salt in a solvent, and sonicating to form a dispersion;
adding a reducing agent to the dispersion and mixing to form a precursor product in the dispersion;
adding acetone to the dispersion and mixing thereby precipitating the precursor product from the mixture in the form of a precipitate;
recovering the precipitate; and
heating the precursor product at a temperature of about 400 to about 1200° C. in an inert atmosphere to form the Ru—C catalyst.

Embodiment 13: The method of embodiments 1-12, wherein the oxidized carbon material is prepared from a carbon material selected from the group consisting of activated carbon, graphene, porous carbon, coal, carbon nanotubes (CNT), carbon black (CB), graphene nanoplatelets (GnP), and mixtures thereof.

Embodiment 14: The method of embodiments 1-13, wherein the dispersion further comprises a salt selected from the group consisting of an iridium salt, a platinum salt, a nickel salt, a cobalt salt, an iron salt, a rhodium salt, a palladium salt, a molybdenum salt and mixtures thereof.

Embodiment 15: The method of embodiments 1-14, wherein the solvent is selected from the group consisting of N-methyl-2-pyrrolidone (NMP), dimethyl sulfoxide, N,N-dimethylformamide, acetone, ethyl acetate, tributyl citrate, diethyl succinate, triethyl citrate, dimethylacetamide and mixtures thereof.

Embodiment 16: The method of embodiments 1-15, wherein the reducing agent is selected from the group consisting of sodium borohydride (NaBH₄), lithium aluminum hydride (LiAlH₄), lithium borohydride (LiBH₄), hydrazine (N₂H₄), sodium hydroxide (NaOH), sodium amalgam (Na(Hg)), diborane (B₂H₆), sodium persulfate (Na₂S₂O₆), potassium iodide (KI), oxalic acid (H₂C₂O₄), formic acid (HCOOH), ascorbic acid (C₆H₈O₆), and zinc amalgam (Zn(Hg)), and mixtures thereof.

Embodiment 17: The method of embodiments 1-16, wherein the Ru—C catalyst has a surface area of about 50 to about 500 square meters per gram (m²/g).

Embodiment 18: The method of embodiments 1-17, wherein the oxidized carbon material is an acid treated carbon material, and the method further comprises preparing the acid treated carbon material by:
mixing a carbon material and an acid to form a mixture, wherein the acid is selected from the group consisting of nitric acid (HNO₃), sulfuric acid (H₂SO₄), acetic acid (AcOH), phosphorus pentoxide (PPA/P₂O₅), hypochlorous acid (HClO), and mixtures thereof; and
heating the mixture.

Embodiment 19: The method of embodiments 1-18, wherein the oxidized carbon material is a steam treated carbon material, and the method further comprises preparing the steam treated carbon material by:
introducing a water vapor into a quartz reactor containing a carbon material; and
passing the water vapor through the quartz reactor to contact the water vapor with the carbon material at a temperature of about 500 to about 1000° C.

Embodiment 20: The method of embodiments 1-19, wherein the oxidized carbon material is a fluorinated carbon material, and the method further comprises preparing the fluorinated carbon material by:
mixing a fluorinating reagent, a carbon material in water, and sonicating to form a mixture;
heating the mixture to form a crude product in the mixture;
separating the crude product from the mixture by centrifugation; and
washing the crude product with two or more solvents to form the fluorinated carbon material.

1. A method for decomposing ammonia (NH₃) to hydrogen (H₂) and nitrogen (N₂), the method comprising:
introducing a H₂-containing feed gas stream into a reactor comprising a carbon material supported metal (M-C) catalyst;
wherein the M-C catalyst comprises a metal selected from the group consisting of ruthenium (Ru), iridium (Ir), platinum (Pt), nickel (Ni), cobalt (Co), iron (Fe), rhodium (Rh), palladium (Pd), Molybdenum (Mo), and mixtures thereof;
passing the H₂-containing feed gas stream through the reactor to contact the H₂-containing feed gas stream with the M-C catalyst at a temperature of about 500° C. to form a reduced M-C catalyst;
introducing and passing an NH₃-containing feed gas stream through the reactor to contact the NH₃-containing feed gas stream with the reduced M-C catalyst at a temperature of about 200 to about 600° C. thereby converting at least a portion of the NH₃ to H₂ and N₂, regenerating the M-C catalyst to form a regenerated M-C catalyst, and producing a residue gas stream, wherein the regenerated M-C catalyst is substantially free of agglomerated particles and sintered particles; and
separating the H₂ from the residue gas stream to generate a H₂-containing product gas stream.

2. The method of claim 1, wherein the M-C catalyst is made in a form selected from the group consisting of powders, pellets, a membrane, a monolithic structure, and combinations thereof.

3. The method of claim 1, wherein the metal is present in the M-C catalyst in an amount of about 0.5 to about 30 wt. % of the M-C catalyst.

4. The method of claim 1, wherein the M-C catalyst further comprises one or more alkali and alkaline earth metal selected from the group consisting of sodium (Na), potassium (K), rubidium (Rb), cesium (Cs), barium (Ba), calcium (Ca), magnesium (Mg), and mixtures thereof.

5. The method of claim 4, wherein the one or more alkali and alkaline earth metal is present in the M-C catalyst in an amount of about 0.01 to about 8 wt. % of the M-C catalyst.

6. The method of claim 1, wherein the H₂ is present in the H₂-containing feed gas stream at a concentration of about 0.01 to about 20 vol. % based on a total volume of the H₂-containing feed gas stream, and wherein the passing the H₂-containing feed gas stream is performed at a flow rate of about 10 to about 50 milliliters per minute (mL/min).

7. The method of claim 1, wherein the NH₃ is present in the NH₃-containing feed gas stream at a concentration of about 90 to about 99.99 vol. % based on a total volume of the NH₃-containing feed gas stream, and wherein the introducing and passing the NH₃-containing feed gas stream is performed at a flow rate of about 10 to about 200 mL/min.

8. The method of claim 1, wherein the introducing and passing the NH₃-containing feed gas stream is performed at a weight hourly space velocity (WHSV) of about 5,000 to about 50,000 milliliters of the NH₃-containing feed gas stream per gram of the M-C catalyst per hour (mL g_{cat}⁻¹ h⁻¹).

9. The method of claim 1, wherein the reactor is selected from the group consisting of a membrane reactor, a fixed-bed reactor, a trickle-bed reactor, a moving bed reactor, a rotating bed reactor, a fluidized bed reactor, and a slurry reactor.

10. The method of claim 1, wherein the reactor is a membrane reactor in the form of a cylindrical tubular reactor comprising:
a cylindrical body portion;
a gas inlet;
a residue gas outlet;
a H₂ gas outlet;
a cylindrical membrane layer comprising the M-C catalyst within the cylindrical body portion of the reactor, wherein an average diameter of the cylindrical membrane layer is at least about 10% less than an average diameter of the cylindrical body portion;
an air gap adjacent to the cylindrical membrane layer;
wherein the air gap is in fluid communication with the H₂ gas outlet;
wherein the gas inlet is in fluid communication with a first end of the cylindrical body portion;
wherein the residue gas outlet is in fluid communication with a second end of the cylindrical body portion; and
wherein the cylindrical membrane layer comprising the M-C catalyst in situ simultaneously decomposes NH₃ to H₂ and N₂, and at least partially separates H₂ from residue gas by rejecting NH₃ and N₂, allowing H₂ to pass through the cylindrical membrane layer.

11. The method of claim 1, wherein the conversion of ammonia to H₂ and N₂ is about 40 to about 99% based on an initial concentration of the NH₃ present in the NH₃-containing feed gas stream.

12. The method of claim 1, wherein the M-C catalyst is a carbon material supported ruthenium (Ru—C) catalyst, and the method further comprises preparing the Ru—C catalyst by:
mixing an oxidized carbon material and a Ru salt in a solvent, and sonicating to form a dispersion;
adding a reducing agent to the dispersion and mixing to form a precursor product in the dispersion;
adding acetone to the dispersion and mixing thereby precipitating the precursor product from the mixture in the form of a precipitate;
recovering the precipitate; and
heating the precursor product at a temperature of about 400 to about 1200° C. in an inert atmosphere to form the Ru—C catalyst.

13. The method of claim 12, wherein the oxidized carbon material is prepared from a carbon material selected from the group consisting of activated carbon, graphene, porous carbon, coal, carbon nanotubes (CNT), carbon black (CB), graphene nanoplatelets (GnP), and mixtures thereof.

14. The method of claim 12, wherein the dispersion further comprises a salt selected from the group consisting of an iridium salt, a platinum salt, a nickel salt, a cobalt salt, an iron salt, a rhodium salt, a palladium salt, a molybdenum salt and mixtures thereof.

15. The method of claim 12, wherein the solvent is selected from the group consisting of N-methyl-2-pyrrolidone (NMP), dimethyl sulfoxide, N,N-dimethylformamide, acetone, ethyl acetate, tributyl citrate, diethyl succinate, triethyl citrate, dimethylacetamide and mixtures thereof.

16. The method of claim 12, wherein the reducing agent is selected from the group consisting of sodium borohydride (NaBH₄), lithium aluminum hydride (LiAlH₄), lithium borohydride (LiBH₄), hydrazine (N₂H₄), sodium hydroxide (NaOH), sodium amalgam (Na(Hg)), diborane (B₂H₆), sodium persulfate (Na₂S₂O₆), potassium iodide (KI), oxalic acid (H₂C₂O₄), formic acid (HCOOH), ascorbic acid (C₆H₈O₆), and zinc amalgam (Zn(Hg)), and mixtures thereof.

17. The method of claim 12, wherein the Ru—C catalyst has a surface area of about 50 to about 500 square meters per gram (m²/g).

18. The method of claim 12, wherein the oxidized carbon material is an acid treated carbon material, and the method further comprises preparing the acid treated carbon material by:
mixing a carbon material and an acid to form a mixture, wherein the acid is selected from the group consisting of nitric acid (HNO₃), sulfuric acid (H₂SO₄), acetic acid (AcOH), phosphorus pentoxide (PPA/P₂O₅), hypochlorous acid (HClO), and mixtures thereof; and
heating the mixture.

19. The method of claim 12, wherein the oxidized carbon material is a steam treated carbon material, and the method further comprises preparing the steam treated carbon material by:
introducing a water vapor into a quartz reactor containing a carbon material; and
passing the water vapor through the quartz reactor to contact the water vapor with the carbon material at a temperature of about 500 to about 1000° C.

20. The method of claim 12, wherein the oxidized carbon material is a fluorinated carbon material, and the method further comprises preparing the fluorinated carbon material by:
mixing a fluorinating reagent, a carbon material in water, and sonicating to form a mixture;
heating the mixture to form a crude product in the mixture;
separating the crude product from the mixture by centrifugation; and
washing the crude product with two or more solvents to form the fluorinated carbon material.
